(19) United States
(12) Patent Application Publication
(10) Pub. No.: US 2016/0036908 A1
(43) Pub. Date: Feb. 4, 2016

(54) ADAPTIVE ADVERTISEMENT BY HOST DEVICES AND DISCOVERY BY EMBEDDED DEVICES

(71) Applicant: QUALCOMM Incorporated, San Diego, CA (US)

(72) Inventors: Ashutosh AGGARWAL, San Diego, CA (US); Salvatore NOTO, San Diego, CA (US); Gregory BURNS, Seattle, WA (US)

(21) Appl. No.: 14/804,064

(22) Filed: Jul. 20, 2015

Related U.S. Application Data
(60) Provisional application No. 62/032,308, filed on Aug. 1, 2014.

(51) Int. Cl. H04L 29/08

(52) U.S. Cl. CPC H04L 67/1065; H04L 67/16; H04L 67/12; H04L 67/101

(57) ABSTRACT

The disclosure relates to adaptive advertisements that embedded devices may discover and use to connect to host devices. In particular, host devices may generally transmit multiple advertisements to signal a willingness to host one or more embedded devices, which may selectively process the advertisements to adaptively attach to a particular host device according to properties associated with the host device and/or requirements associated with the embedded devices. Furthermore, the host devices may have overload thresholds that control whether the host devices should be “discoverable” such that the advertisements may be dynamically adjusted (or suspended) according to current load status and connected embedded devices may be redirected to another target host device to shed load when the current load status exceeds the overload threshold.

### CROSS-REFERENCE TO RELATED APPLICATIONS

The present application claims the benefit of U.S. Provisional Patent Application Ser. No. 62/032,308, entitled “ADAPTIVE ADVERTISEMENT BY HOST DEVICES AND DISCOVERY BY EMBEDDED DEVICES,” filed Aug. 1, 2014, assigned to the assignee hereof, and hereby expressly incorporated herein by reference in its entirety.

### TECHNICAL FIELD

The various aspects described herein generally relate to adaptive advertisements that embedded devices may discover and use to connect to host devices, and in particular, to selectively processing different advertisement types that the embedded devices receive from one or more host devices willing to host the embedded devices such that the embedded devices may adaptively attach to a particular host device according to properties associated with the host device and/or requirements associated with the embedded devices.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

Accordingly, in the near future, increasing development in IoT technologies will lead to numerous IoT devices surrounding a user at home, in vehicles, at work, and many other locations and personal spaces. Due at least in part to the potentially large number of heterogeneous IoT devices and other physical objects that may be in use within a controlled IoT network, which may interact with one another and/or be used in many different ways, well-defined and reliable communication interfaces are generally needed to connect the various heterogeneous IoT devices such that the various heterogeneous IoT devices can be appropriately configured, managed, and communicate with one another to exchange information. In that context, various efforts have been made to provide environments that allow distributed applications to run across different device classes and emphasize mobility, security, and dynamic configuration independent from any underlying operating system, hardware, and/or software on the devices in the environment. However, embedded systems that may have substantial prevalence in IoT environments are designed to provide specific functionality running on a microcontroller embedded within a larger device. As such, because an embedded system typically only performs a specific function or a small number of specific functions, embedded systems are often designed with limited memory size, processor speed, available power, peripherals, and so on in order to reduce the size and cost associated with the product. In other words, because embedded systems tend to have constrained operating environments, embedded systems typically lack the resources that may be needed to support multithreading, many network connections, and other requirements associated with distributed programming environments. Nonetheless, substantial benefits may be realized from connecting embedded systems and other devices with constrained operating environments in distributed programming environments.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects disclosed herein in a simplified form to precede the detailed description presented below.

According to various exemplary aspects, the disclosure generally relates to adaptive advertisements that embedded devices may discover and selectively process to connect to a particular host device and thereby join a proximity-based distributed bus. In particular, host devices may generally transmit multiple advertisements to signal a willingness to host one or more embedded devices, which may selectively process the advertisements to adaptively connect to a particular host device according to properties associated with the host devices and/or requirements associated with the embedded devices. Furthermore, the host devices may have overload thresholds that control whether the host devices should be “discoverable” such that the advertisements may be dynamically adjusted (or suspended) according to current load status and connected embedded devices may be redirected to another target host device to shed load when the current load status exceeds the overload threshold. More particularly, a particular embedded device may receive advertisements from one or more host devices, select one of the host devices based on information included in the advertisements, and connect to the selected host device to join a proximity-based distributed bus. For example, according to various aspects, each advertisement may include one or more properties associated with the respective host device such that the host device may be selected based on a local decision tree that the embedded device uses to filter the one or more properties associated with each host device (e.g., each embedded device may have a different decision tree used to filter the properties associated with each host device). In another example, each advertisement may include an index derived from one or more weighting factors applied to the one or more properties associated with the respective host device such that the embedded device may select the host device based on which host device has a highest index. Furthermore, according to various aspects, the advertisements received from each host device may include a first advertisement having a first type and a second advertisement having a second type in an unsolicited mode, wherein the advertisements having the first type each include the properties associated with the respective host device and the advertisements having the second type each include the index derived from the weighting factors applied to the properties associated with the respective host device. Alternatively, in a solicited mode, the embedded device may request advertisements that have either the first type or the second type from each host device, wherein each host device may only transmit advertisements having the first type or the second type to the requesting embedded device depending on what advertisement type the embedded device requested. Furthermore, according to various aspects, the host devices may each dynamically adjust one or more of the advertisements having the first type or the advertisements having the second type based on current loads associated therewith. Further still, the embedded device may receive a redirection message that the selected host device may transmit to the embedded device in response to determining that a current load associated therewith exceeds an overload threshold, wherein the redirection message may include information associated with a target host device and the embedded device may then connect to the target host device identified in the redirection message.

According to various aspects, a method for adaptive advertisement discovery and selection may comprise, among other things, receiving advertisements from one or more host devices, selecting a host device based on information included in the advertisements, and connecting to the selected host device to join a proximity-based distributed bus.

According to various aspects, an embedded device may comprise a receiver configured to receive advertisements from one or more host devices and one or more processors configured to select a host device based on information included in the advertisements and connect to the selected host device to join a proximity-based distributed bus.

According to various aspects, an apparatus may comprise means for receiving advertisements from one or more host devices, means for selecting a host device based on information included in the advertisements, and means for connecting to the selected host device to join a proximity-based distributed bus.

According to various aspects, a computer-readable storage medium may have computer-executable instructions recorded thereon, wherein executing the computer-executable instructions on an embedded device having one or more processors may cause the one or more processors to receive advertisements from one or more host devices, select a host device based on information included in the advertisements, and connect to the selected host device to join a proximity-based distributed bus.

Other objects and advantages associated with the various aspects disclosed herein will be apparent to those skilled in the art based on the following detailed description and the accompanying drawings.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary high-level system architecture of a wireless communications system in which one or more host devices may adaptively transmit advertisements that embedded devices can discover and select to connect to a proximity-based distributed bus, according to various aspects.

FIG. 2A-2E illustrate exemplary high-level system architectures of additional wireless communications systems that may include various Internet of Things (IoT) devices, including one or more host devices that may transmit adaptive advertisements and one or more embedded devices that can discover and use the adaptive advertisements to select a particular host device and thereby connect to a proximity-based distributed bus, according to various aspects.

FIG. 3 illustrates exemplary communication devices that may correspond to host devices that provide attachments to a proximity-based distributed bus or embedded devices that connect to a host device to connect to the proximity-based distributed bus, according to various aspects.

FIG. 4A illustrates an exemplary IoT device and FIG. 4B illustrates an exemplary passive IoT device, which may also correspond to host devices that provide attachments to a proximity-based distributed bus or embedded devices that connect to the proximity-based distributed bus via a host device, according to various aspects.

FIG. 5 illustrates a communication device that includes logic configured to perform functionality, according to various aspects.

FIG. 6 illustrates an exemplary server, according to various aspects.

FIG. 7 illustrates a wireless communication network that may support discoverable device-to-device (D2D) (or peer-to-peer (P2P)) services that can enable direct D2D communication, which may include direct D2D and/or P2P communication over a proximity-based distributed bus, according to various aspects

FIG. 8 illustrates an exemplary environment in which discoverable D2D services may be used to establish a proximity-based distributed bus over which various devices may communicate using D2D technology, according to various aspects.

FIG. 9 illustrates an exemplary signaling flow in which discoverable D2D services may be used to establish a proximity-based distributed bus over which various devices may communicate using D2D technology, according to various aspects.

FIG. 10A illustrates an exemplary proximity-based distributed bus that may be formed between two host devices to support D2D communication between the host devices, while FIG. 10B illustrates an exemplary proximity-based distributed bus in which one or more embedded devices may connect to a host device to connect to the proximity-based distributed bus, according to various aspects.

FIG. 11 illustrates exemplary high-level operation in which adaptive advertisements may be used to connect embedded devices to a proximity-based distributed bus, according to various aspects.

FIG. 12 illustrates an exemplary host device that may prepare and transmit advertisements to allow embedded devices to connect to a proximity-based distributed bus, according to various aspects.

FIG. 13 illustrates exemplary processing in which a host device may derive a weighted property index used in adaptive advertisements transmitted to embedded devices, according to various aspects.

FIG. 14 illustrates exemplary processing in which an embedded device may process adaptive advertisements received from host devices, according to various aspects.

FIG. 15 illustrates an exemplary method in which a host device may dynamically adjust advertisements according to load, according to various aspects.

FIG. 16 illustrates an exemplary call flow in which a host device connected to a particular embedded device may perform load shedding to connect the embedded device to another target host device, according to various aspects.

FIG. 17 illustrates an exemplary block diagram that may correspond to a host device that provides an attachment to a proximity-based distributed bus or an embedded device that connects to a host device to attach to the proximity-based distributed bus, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, a client device, referred to herein as a host device, an embedded device, a user equipment (UE), or the like, may be mobile or stationary, and may communicate with a radio access network (RAN). As used herein, the terms “client device,” “host device,” “embedded device,” and variants thereof may be interchangeable and refer to an “access terminal,” an “AT,” a “wireless device,” a “subscriber device,” a “subscriber terminal,” a “subscriber station,” a “user terminal” (or UT), a “mobile terminal,” a “mobile station,” a “mobile device,” and variations thereof. Generally, client devices can communicate with a core network via the RAN, and through the core network the client devices can be connected with external networks such as the Internet. Of course, other mechanisms of connecting to the core network and/or the Internet are also possible for the client devices, such as over wired access networks, Wi-Fi networks (e.g., based on IEEE 802.11, etc.) and so on. Client devices can be embodied by any of a number of types of devices including but not limited to PC cards, compact flash devices, external or internal modems, wireless or wireline phones, and so on. A communication link through which client devices can send signals to the RAN is called an uplink channel (e.g., a reverse traffic channel, a reverse control channel, an access channel, etc.). A communication link through which the RAN can send signals to client devices is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

As used herein, the term “host device” may generally refer to any suitable client device that has sufficient memory resources, available energy, computing power, and other resources and capabilities to run an operating system that can support multiple processes and multiple threads and thereby run an appropriate daemon, bus router, or other process that can provide an attachment to a proximity-based distributed bus and thereby enable direct peer-to-peer (P2P) or device-to-device (D2D) communication with other devices attached to the proximity-based distributed bus.

As used herein, the term “embedded device” may generally refer to any suitable client device that lacks sufficient resources to run a daemon, bus router, or other process needed to attach to a proximity-based distributed bus that supports direct peer-to-peer (P2P) or device-to-device (D2D) communication with other devices attached to the proximity-based distributed bus. For example, an “embedded device” may generally refer to a client device designed to provide specific or limited functionality running on a microcontroller embedded within a larger device such that embedded devices often have limited memory size, processor speed, available power, peripherals, user interfaces, or all of the above.

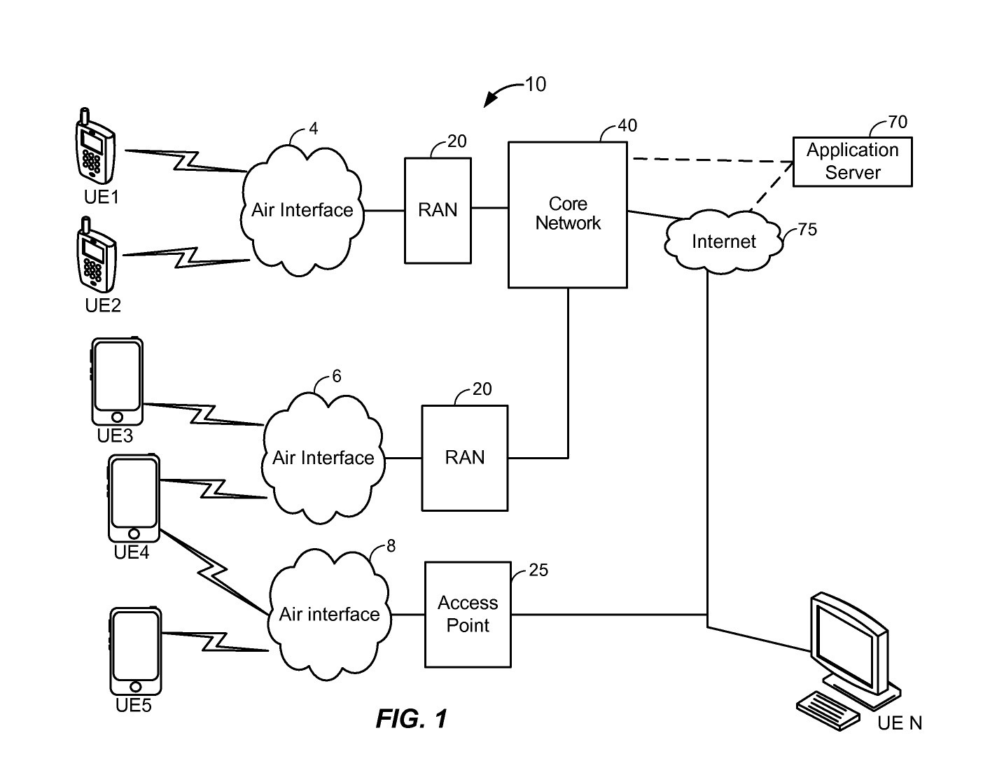

Referring now to FIG. 1, an exemplary wireless communications system 100 may include UEs 1 . . . N, which can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EV-DO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of Wi-Fi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 (e.g., a Wi-Fi router with wired and/or wireless connectivity may correspond to the access point 125).

Referring still to FIG. 1, certain UEs may be configured to communicate using a near-field communication (NFC) interface. For example, UE 1 may have an NFC interface in which input power may be provided to a transmitter that uses the input power to generate a magnetic field for providing energy transfer and UE 2 may likewise have an NFC interface in which a receiver may couple to the magnetic field that UE 1 to generate an output power that may be stored or consumed therein. Accordingly, when the resonant frequency of the receiver at UE 2 matches the resonant frequency of the transmitter at UE 1, transmission losses between the transmitter and the receiver are minimal when the receiver is located in the “near-field” of the magnetic field and energy transfer may thereby occur between UE 1 and UE 2 in order to enable communication therebetween. Furthermore, those skilled in the art will appreciate that the NFC interface in UE 1 may include a similar receiver and the NFC interface in UE 2 may include a similar transmitter in order to facilitate NFC in the opposite direction.

Referring to FIG. 1, an application server 170 is shown as connected to the Internet 175, the core network 140, or both. The application server 170 can be implemented as a plurality of structurally separate servers, or alternately may correspond to a single server. In various embodiments, the application server 170 may be configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175, and/or to provide content (e.g., web page downloads) to the UEs.

In the wireless communications system 100 shown in FIG. 1, one or more host devices may be attached to a proximity-based distributed bus and configured to adaptively transmit advertisements to signal a willingness to host one or more embedded devices seeking to attach to the proximity-based distributed bus. Accordingly, as will be described in further detail below, the one or more embedded devices may discover and process the adaptively transmitted advertisements from the one or more host devices and connect to a particular host device in order to join or otherwise attach to the proximity-based distributed bus. For example, in various use cases, one or more of the UEs 1 . . . N may have sufficient resources to run an environment that supports distributed programming, whereby the one or more UEs may be considered “host devices” that can run respective bus routers, daemons, or other processes that may provide attachments to the proximity-based distributed bus. Furthermore, in various use cases, one or more of the UEs 1 . . . N may have constrained operating environments and lack sufficient resources to run the distributed programming environment, wherein such UEs may be considered “embedded devices” that lack sufficient capabilities to run a bus router, daemon, or other suitable process that can provide a local attachment to the proximity-based distributed bus. Nonetheless, as will be described in further detail below, the embedded devices can “borrow” the bus router, daemon, or other suitable process running a particular host device that is attached to the proximity-based distributed bus. As such, each embedded device may connect to a particular host device to attach to and communicate over the proximity-based distributed bus, wherein the particular host device may be selected based on information included in the advertisements adaptively transmitted from the host devices depending on properties associated with the host device(s) and/or requirements associated with the embedded device(s).

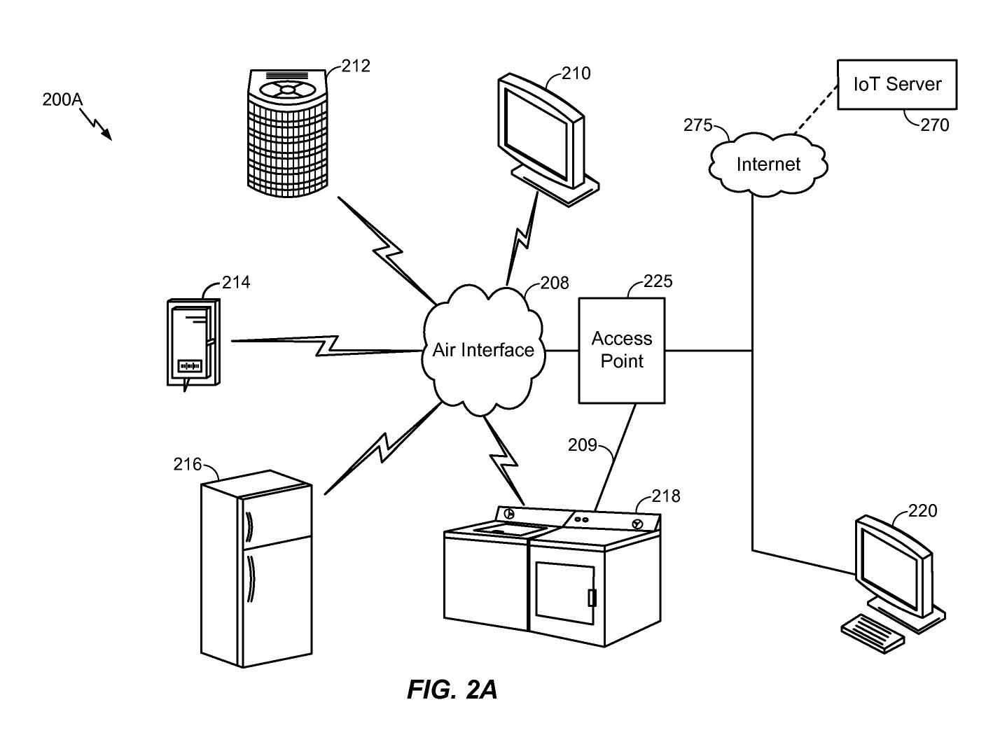

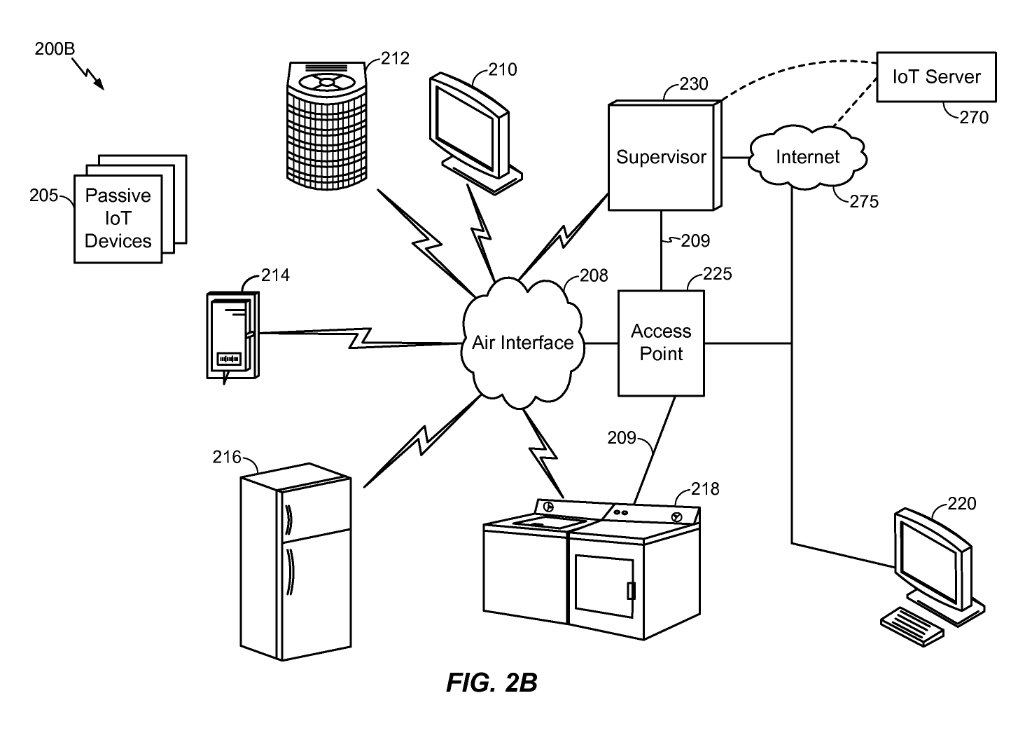

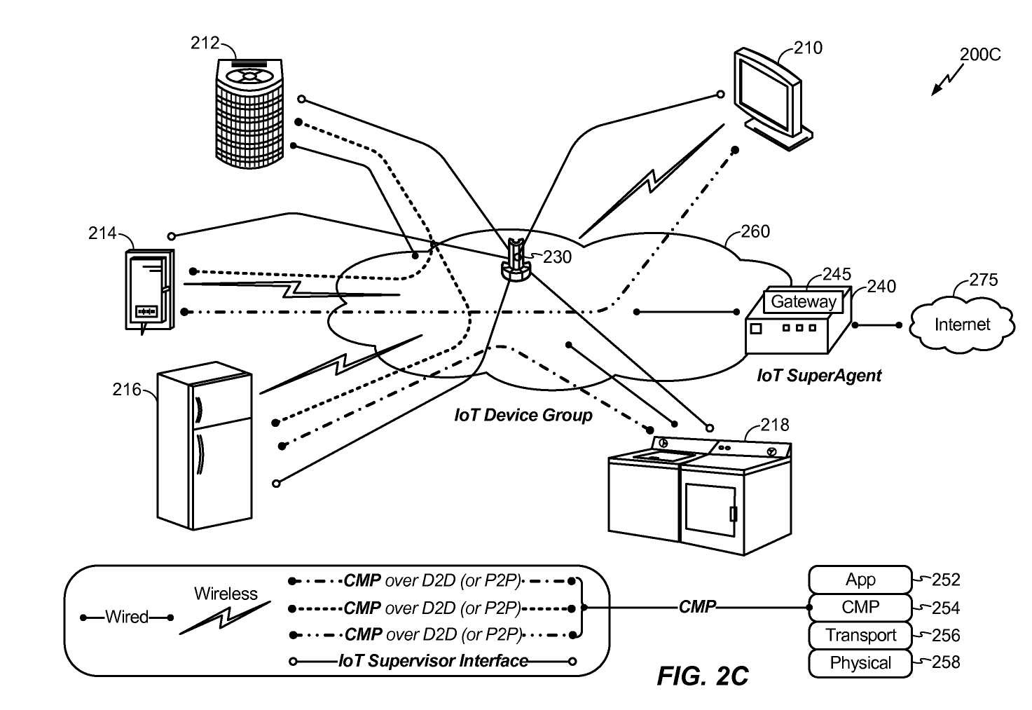

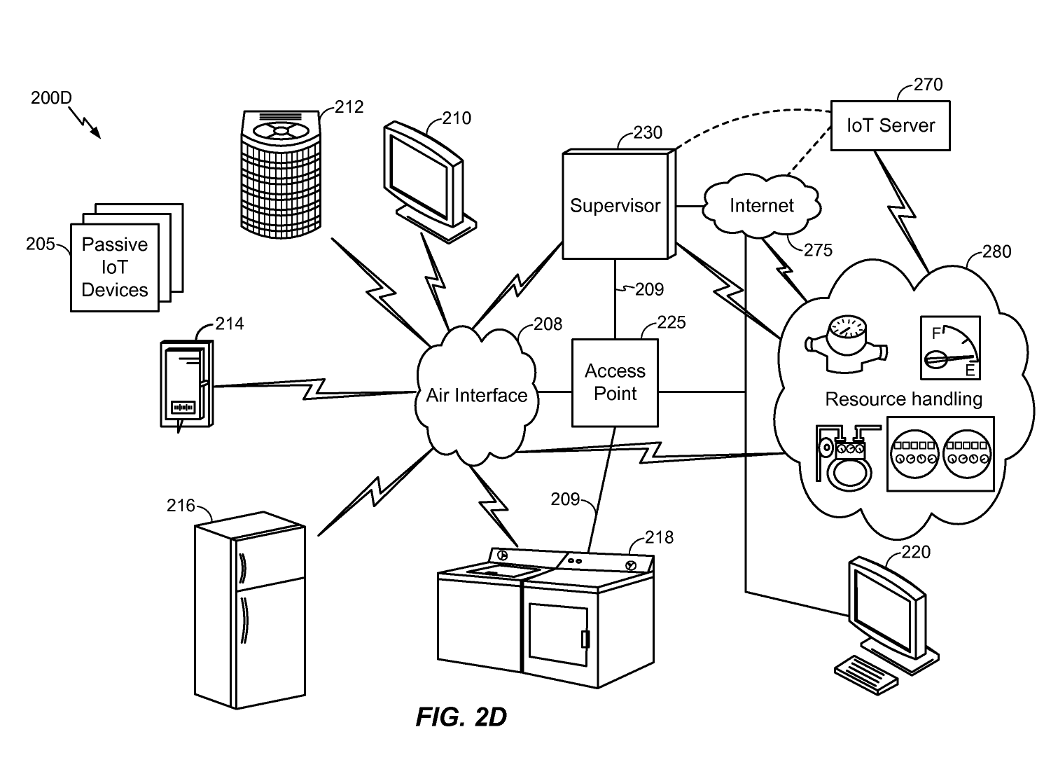

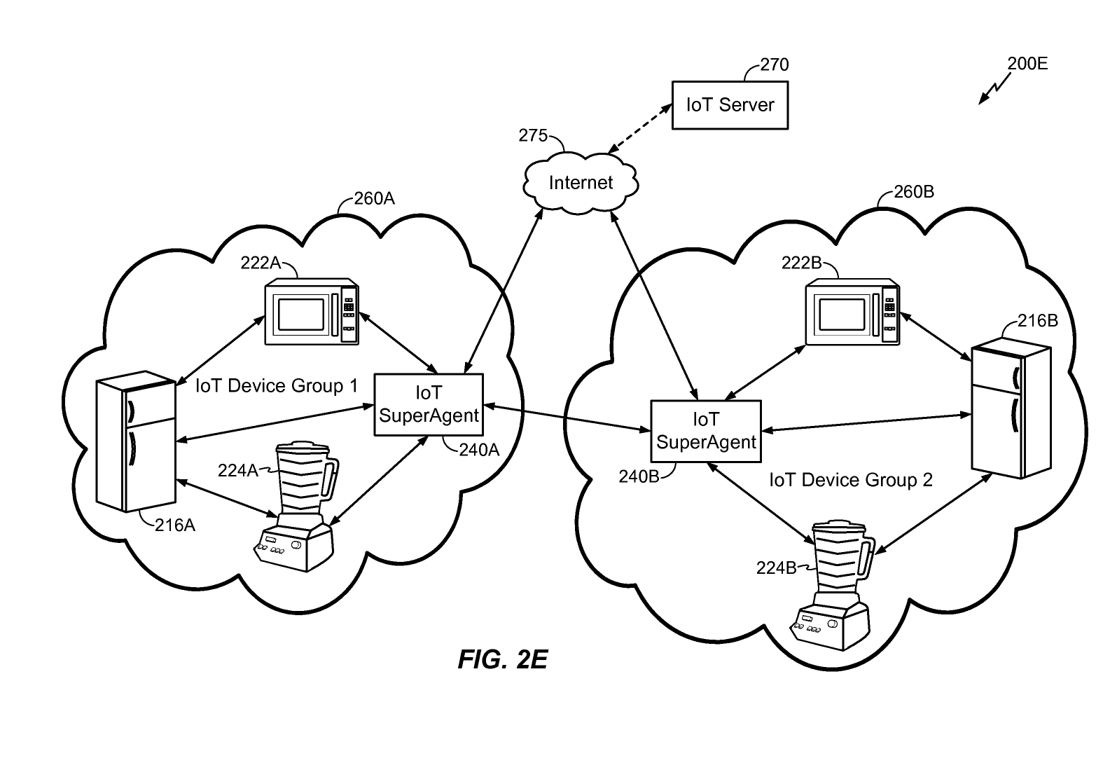

According to various aspects, FIG. 2A-2E illustrate exemplary high-level system architectures of additional wireless communications systems in which one or more host devices may adaptively transmit advertisements that embedded devices can discover and select to connect to a proximity-based distributed bus.

More particularly, referring to FIG. 2A, the wireless communications system 200A shown therein may include one or more host devices may adaptively transmit advertisements that embedded devices can discover and select to attach to a proximity-based distributed bus, wherein the wireless communications system 200A contains multiple IoT devices, which may include a television 210, an outdoor air conditioning unit 212, a thermostat 214, a refrigerator 216, a washer and dryer 218, etc.

Referring to FIG. 2A, IoT devices 210-218 are configured to communicate with an access network (e.g., an access point 225) over a physical communications interface or layer, shown in FIG. 2A as air interface 208 and a direct wired connection 209. The air interface 208 can comply with a wireless Internet protocol (IP), such as IEEE 802.11. Although FIG. 2A illustrates IoT devices 210-218 communicating over the air interface 208 and IoT device 218 communicating over the direct wired connection 209, each IoT device may communicate over a wired or wireless connection, or both.

The Internet 275 includes a number of routing agents and processing agents (not shown in FIG. 2A for the sake of convenience). The Internet 275 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 2A, a computer 220, such as a desktop or personal computer (PC), is shown as connecting to the Internet 275 directly (e.g., over an Ethernet connection or Wi-Fi or 802.11-based network). The computer 220 may have a wired connection to the Internet 275, such as a direct connection to a modem or router, which, in an example, can correspond to the access point 225 (e.g., for a Wi-Fi router with both wired and wireless connectivity). Alternatively, rather than being connected to the access point 225 and the Internet 275 over a wired connection, the computer 220 may be connected to the access point 225 over air interface 208 or another wireless interface, and access the Internet 275 over the air interface 208. Although illustrated as a desktop computer, computer 220 may be a laptop computer, a tablet computer, a PDA, a smart phone, or the like. The computer 220 may be an IoT device and/or contain functionality to manage an IoT network/group, such as the network/group of IoT devices 210-218.

The access point 225 may be connected to the Internet 275 via, for example, an optical communication system, such as FiOS, a cable modem, a digital subscriber line (DSL) modem, or the like. The access point 225 may communicate with IoT devices 210-220 and the Internet 275 using the standard Internet protocols (e.g., TCP/IP).

Referring to FIG. 2A, an IoT server 270 is shown as connected to the Internet 275. The IoT server 270 can be implemented as a plurality of structurally separate servers, or alternately may correspond to a single server. In an aspect, the IoT server 270 is optional (as indicated by the dotted line), and the group of IoT devices 210-220 may be a peer-to-peer (P2P) network. In such a case, the IoT devices 210-220 can communicate with each other directly over the air interface 208 and/or the direct wired connection 209 using appropriate device-to-device (D2D) communication technology. Alternatively, or additionally, some or all of the IoT devices 210-220 may be configured with a communication interface independent of the air interface 208 and the direct wired connection 209. For example, if the air interface 208 corresponds to a Wi-Fi interface, one or more of the IoT devices 210-220 may have Bluetooth or NFC interfaces for communicating directly with each other or other Bluetooth or NFC-enabled devices. In a peer-to-peer network, service discovery schemes can multicast the presence of nodes, their capabilities, and group membership. The peer-to-peer devices can establish associations and subsequent interactions based on this information, wherein the description provided herein that relates to the adaptive advertisement, discovery, and selection may generally occur in such peer-to-peer contexts (e.g., a proximity-based distributed bus).

In accordance with various aspects, FIG. 2B illustrates a high-level architecture of another wireless communications system 200B that contains a plurality of IoT devices. In general, the wireless communications system 200B shown in FIG. 2B may include various components that are the same and/or substantially similar to the wireless communications system 200A shown in FIG. 2A, which was described in greater detail above (e.g., various IoT devices, including a television 210, outdoor air conditioning unit 212, thermostat 214, refrigerator 216, and washer and dryer 218, that are configured to communicate with an access point 225 over an air interface 208 and/or a direct wired connection 209, a computer 220 that directly connects to the Internet 275 and/or connects to the Internet 275 through access point 225, and an IoT server 270 accessible via the Internet 275, etc.). As such, for brevity and ease of description, various details relating to certain components in the wireless communications system 200B shown in FIG. 2B may be omitted herein to the extent that the same or similar details have already been provided above in relation to the wireless communications system 200A illustrated in FIG. 2A.

Referring to FIG. 2B, the wireless communications system 200B may include a supervisor device 230, which may alternatively be referred to as an IoT manager 230 or IoT manager device 230. As such, where the following description uses the term “supervisor device” 230, those skilled in the art will appreciate that any references to an IoT manager, group owner, or similar terminology may refer to the supervisor device 230 or another physical or logical component that provides the same or substantially similar functionality.

In various embodiments, the supervisor device 230 may generally observe, monitor, control, or otherwise manage the various other components in the wireless communications system 200B. For example, the supervisor device 230 can communicate with an access network (e.g., access point 225) over air interface 208 and/or a direct wired connection 209 to monitor or manage attributes, activities, or other states associated with the various IoT devices 210-220 in the wireless communications system 200B. The supervisor device 230 may have a wired or wireless connection to the Internet 275 and optionally to the IoT server 270 (shown as a dotted line). The supervisor device 230 may obtain information from the Internet 275 and/or the IoT server 270 that can be used to further monitor or manage attributes, activities, or other states associated with the various IoT devices 210-220. The supervisor device 230 may be a standalone device or one of IoT devices 210-220, such as computer 220. The supervisor device 230 may be a physical device or a software application running on a physical device. The supervisor device 230 may include a user interface that can output information relating to the monitored attributes, activities, or other states associated with the IoT devices 210-220 and receive input information to control or otherwise manage the attributes, activities, or other states associated therewith. Accordingly, the supervisor device 230 may generally include various components and support various wired and wireless communication interfaces to observe, monitor, control, or otherwise manage the various components in the wireless communications system 200B.

The wireless communications system 200B shown in FIG. 2B may include one or more passive IoT devices 205 (in contrast to the active IoT devices 210-220) that can be coupled to or otherwise made part of the wireless communications system 200B. In general, the passive IoT devices 205 may include barcoded devices, Bluetooth devices, radio frequency (RF) devices, RFID tagged devices, infrared (IR) devices, NFC tagged devices, or any other suitable device that can provide an identifier and attributes associated therewith to another device when queried over a short range interface. Active IoT devices may detect, store, communicate, act on, and/or the like, changes in attributes of passive IoT devices.

For example, the one or more passive IoT devices 205 may include a coffee cup passive IoT device 205 and an orange juice container passive IoT device 205 that each have an RFID tag or barcode. A cabinet IoT device (not shown) and the refrigerator IoT device 216 may each have an appropriate scanner or reader that can read the RFID tag or barcode to detect when the coffee cup passive IoT device 205 and/or the orange juice container passive IoT device 205 have been added or removed. In response to the cabinet IoT device detecting the removal of the coffee cup passive IoT device 205 and the refrigerator IoT device 216 detecting the removal of the orange juice container passive IoT device 205, the supervisor device 230 may receive one or more signals that relate to the activities detected at the cabinet IoT device and the refrigerator IoT device 216. The supervisor device 230 may then infer that a user is drinking orange juice from the coffee cup passive IoT device 205 and/or likes to drink orange juice from the coffee cup passive IoT device 205.

Although the foregoing describes the passive IoT devices 205 as having some form of RFID tag or barcode communication interface, the passive IoT devices 205 may include one or more devices or other physical objects that do not have such communication capabilities. For example, certain IoT devices may have appropriate scanner or reader mechanisms that can detect shapes, sizes, colors, and/or other observable features associated with the passive IoT devices 205 to identify the passive IoT devices 205. In this manner, any suitable physical object may communicate an identity and one or more attributes associated therewith, become part of the wireless communications system 200B, and be observed, monitored, controlled, or otherwise managed with the supervisor device 230. Further, passive IoT devices 205 may be coupled to or otherwise made part of the wireless communications system 200A in FIG. 2A and observed, monitored, controlled, or otherwise managed in a substantially similar manner.

In accordance with various aspects, FIG. 2C illustrates a high-level architecture of another wireless communications system 200C that contains a plurality of IoT devices. In general, the wireless communications system 200C shown in FIG. 2C may include various components that are the same and/or substantially similar to the wireless communications systems 200A and 200B shown in FIGS. 2A and 2B, respectively, which were described in greater detail above. As such, for brevity and ease of description, various details relating to certain components in the wireless communications system 200C shown in FIG. 2C may be omitted herein to the extent that the same or similar details have already been provided above in relation to the wireless communications systems 200A and 200B illustrated in FIGS. 2A and 2B, respectively.

The wireless communications system 200C shown in FIG. 2C illustrates exemplary peer-to-peer communications between the IoT devices 210-218 and the supervisor device 230. As shown in FIG. 2C, the supervisor device 230 communicates with each of the IoT devices 210-218 over an IoT supervisor interface. Further, IoT devices 210 and 214, IoT devices 212, 214, and 216, and IoT devices 216 and 218, communicate directly with each other.

The IoT devices 210-218 make up an IoT device group 260. The IoT device group 260 may comprise a group of locally connected IoT devices, such as the IoT devices connected to a user's home network. Although not shown, multiple IoT device groups may be connected to and/or communicate with each other via an IoT SuperAgent 240 connected to the Internet 275. At a high level, the supervisor device 230 manages intra-group communications, while the IoT SuperAgent 240 can manage inter-group communications. Although shown as separate devices, the supervisor device 230 and the IoT SuperAgent 240 may be, or reside on, the same device (e.g., a standalone device or an IoT device, such as computer 220 in FIG. 2A). Alternatively, the IoT SuperAgent 240 may correspond to or include the functionality of the access point 225. As yet another alternative, the IoT SuperAgent 240 may correspond to or include the functionality of an IoT server, such as IoT server 270. The IoT SuperAgent 240 may encapsulate gateway functionality 245.

Each IoT device 210-218 can treat the supervisor device 230 as a peer and transmit attribute/schema updates to the supervisor device 230. When an IoT device needs to communicate with another IoT device, the IoT device can request the pointer to that IoT device from the supervisor device 230 and then communicate with the target IoT device as a peer. The IoT devices 210-218 communicate with each other over a peer-to-peer communication network using a common messaging protocol (CMP). As long as two IoT devices are CMP-enabled and connected over a common communication transport, they can communicate with each other. In the protocol stack, the CMP layer 254 is below the application layer 252 and above the transport layer 256 and the physical layer 258.

In accordance with various aspects, FIG. 2D illustrates a high-level architecture of another wireless communications system 200D that contains a plurality of IoT devices. In general, the wireless communications system 200D shown in FIG. 2D may include various components that are the same and/or substantially similar to the wireless communications systems 200A-200C shown in FIGS. 2A-2C, respectively, which were described in greater detail above. As such, for brevity and ease of description, various details relating to certain components in the wireless communications system 200D shown in FIG. 2D may be omitted herein to the extent that the same or similar details have already been provided above in relation to the wireless communications systems 200A-200C illustrated in FIGS. 2A-2C, respectively.

The Internet 275 is a “resource” that can be regulated using the concept of the IoT. However, the Internet 275 is just one example of a resource that is regulated, and any resource could be regulated using the concept of the IoT. Other resources that can be regulated include, but are not limited to, electricity, gas, storage, security, and the like. An IoT device may be connected to the resource and thereby regulate the resource, or the resource could be regulated over the Internet 275. FIG. 2D illustrates several resources 280, such as natural gas, gasoline, hot water, and electricity, wherein the resources 280 can be regulated in addition to and/or over the Internet 275.

IoT devices can communicate with each other to regulate their use of a resource 280. For example, IoT devices such as a toaster, a computer, and a hairdryer may communicate with each other over a Bluetooth communication interface to regulate their use of electricity (the resource 280). As another example, IoT devices such as a desktop computer, a telephone, and a tablet computer may communicate over a Wi-Fi communication interface to regulate their access to the Internet 275 (the resource 280). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 270, which has logic to regulate their use of the resource 280 based on information received from the IoT devices.

In accordance with various aspects, FIG. 2E illustrates a high-level architecture of another wireless communications system 200E that contains a plurality of IoT devices. In general, the wireless communications system 200E shown in FIG. 2E may include various components that are the same and/or substantially similar to the wireless communications systems 200A-200D shown in FIGS. 2A-2D, respectively, which were described in greater detail above. As such, for brevity and ease of description, various details relating to certain components in the wireless communications system 200E shown in FIG. 2E may be omitted herein to the extent that the same or similar details have already been provided above in relation to the wireless communications systems 200A-200D illustrated in FIGS. 2A-2D, respectively.

The wireless communications system 200E includes two IoT device groups 260A and 260B. Multiple IoT device groups may be connected to and/or communicate with each other via an IoT SuperAgent connected to the Internet 275. At a high level, an IoT SuperAgent may manage inter-group communications among IoT device groups. For example, in FIG. 2E, the IoT device group 260A includes IoT devices 216A, 222A, and 224A and an IoT SuperAgent 240A, while IoT device group 260B includes IoT devices 216B, 222B, and 224B and an IoT SuperAgent 240B. As such, the IoT SuperAgents 240A and 240B may connect to the Internet 275 and communicate with each other over the Internet 275 and/or communicate with each other directly to facilitate communication between the IoT device groups 260A and 260B. Furthermore, although FIG. 2E illustrates two IoT device groups 260A and 260B communicating with each other via IoT SuperAgents 240A and 240B, those skilled in the art will appreciate that any number of IoT device groups may suitably communicate with each other using IoT SuperAgents.

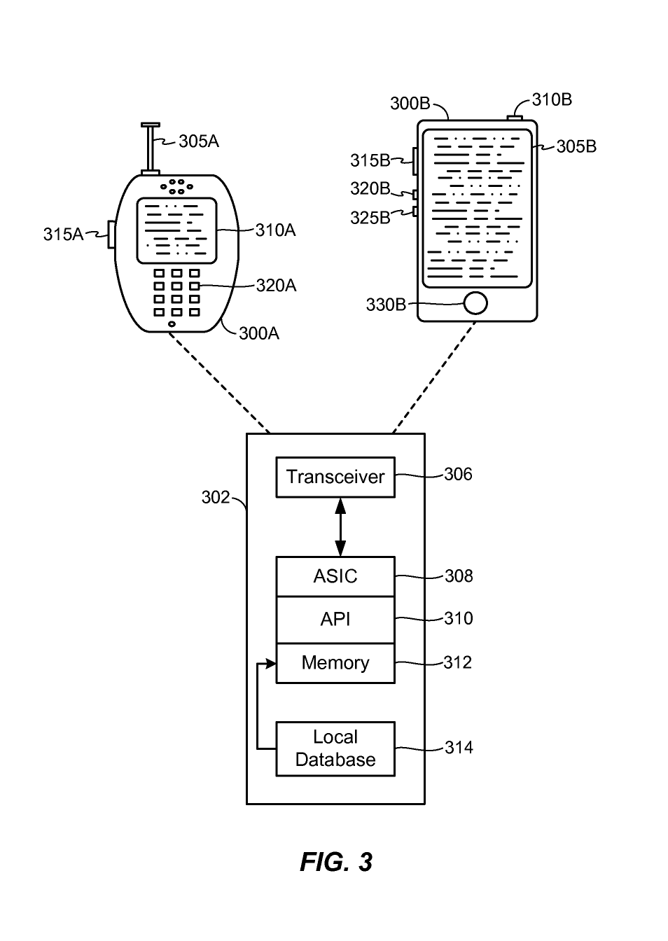

According to one aspect of the disclosure, FIG. 3 illustrates exemplary communication devices that may correspond to host devices that provide attachments to a proximity-based distributed bus or embedded devices that connect to a host device to attach to the proximity-based distributed bus. In particular, referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to Wi-Fi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from a radio access network (RAN) that may ultimately come from a core network, the Internet, and/or other remote servers and networks (e.g., an application server, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, one embodiment can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the features of the UEs 300A and 300B in FIG. 3 are not limited to the illustrated features or arrangement.

The wireless communication between the UEs 300A and/or 300B and the RAN can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments disclosed herein and are merely to aid in the description of aspects of the disclosed embodiments.

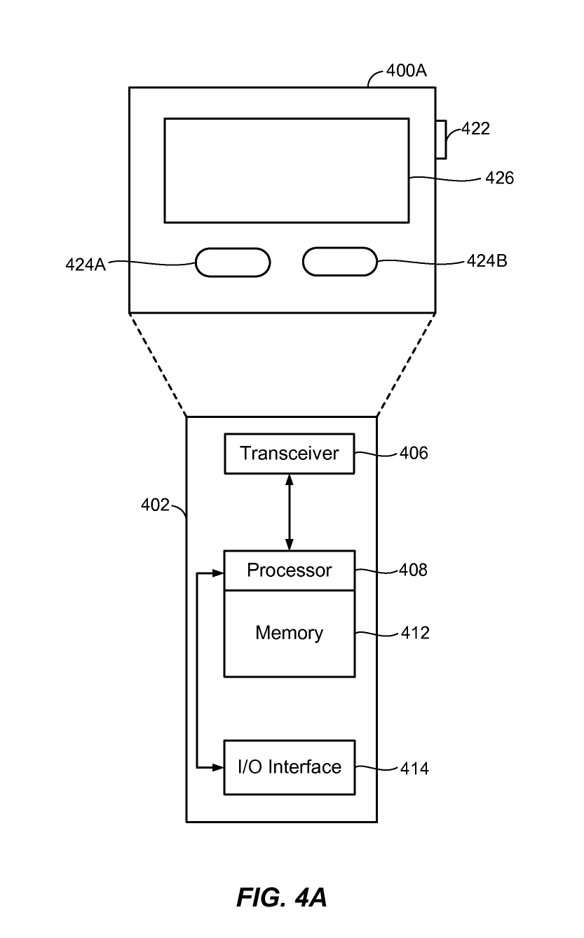

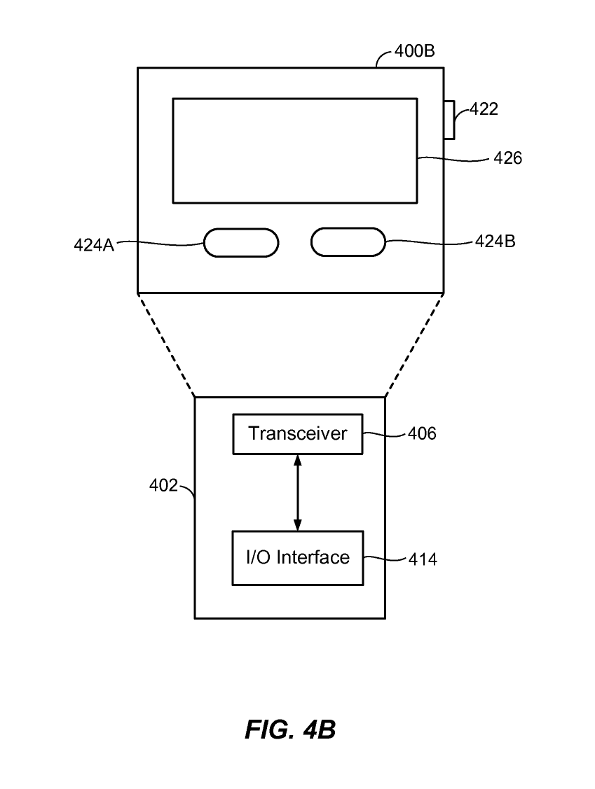

According to various aspects, FIG. 4A illustrates an exemplary Internet of Things (IoT) device 400A and FIG. 4B illustrates an exemplary passive IoT device 400B, either or both of which may also correspond to host devices that provide attachments to a proximity-based distributed bus or embedded devices that connect to the proximity-based distributed bus via a host device. While external appearances and/or internal components can differ significantly among IoT devices, most IoT devices will have some sort of user interface, which may comprise a display and a means for user input. IoT devices without a user interface can be communicated with remotely over a wired or wireless network, such as the air interfaces in FIGS. 1 and 2A-2B.

As shown in FIG. 4A, in an example configuration for the IoT device 400A, an external casing of IoT device 400A may be configured with a display 426, a power button 422, and two control buttons 424A and 424B, among other components, as is known in the art. The display 426 may be a touchscreen display, in which case the control buttons 424A and 424B may not be necessary. While not shown explicitly as part of IoT device 400A, the IoT device 400A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 400A, can be embodied with different hardware configurations, a basic high-level configuration for internal hardware components is shown as platform 402 in FIG. 4A. The platform 402 can receive and execute software applications, data and/or commands transmitted over a network interface, such as the air interfaces in FIGS. 1 and 2A-2B and/or a wired interface. The platform 402 can also independently execute locally stored applications. The platform 402 can include one or more transceivers 406 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 408, such as a microcontroller, microprocessor, application specific integrated circuit, digital signal processor (DSP), programmable logic circuit, or other data processing device, which will be generally referred to as processor 408. The processor 408 can execute application programming instructions within a memory 412 of the IoT device. The memory 412 can include one or more of read-only memory (ROM), random-access memory (RAM), electrically erasable programmable ROM (EEPROM), flash cards, or any memory common to computer platforms. One or more input/output (I/O) interfaces 414 can be configured to allow the processor 408 to communicate with and control from various I/O devices such as the display 426, power button 422, control buttons 424A and 424B as illustrated, and any other devices, such as sensors, actuators, relays, valves, switches, and the like associated with the IoT device 400A.

Accordingly, various aspects can include an IoT device (e.g., IoT device 400A) including the ability to perform the functions described herein. As will be appreciated by those skilled in the art, the various logic elements can be embodied in discrete elements, software modules executed on a processor (e.g., processor 408) or any combination of software and hardware to achieve the functionality disclosed herein. For example, transceiver 406, processor 408, memory 412, and I/O interface 414 may all be used cooperatively to load, store and execute the various functions disclosed herein and thus the logic to perform these functions may be distributed over various elements. Alternatively, the functionality could be incorporated into one discrete component. Therefore, the features of the IoT device 400A in FIG. 4A are to be considered merely illustrative and the IoT device 400A is not limited to the illustrated features or arrangement shown in FIG. 4A.

FIG. 4B illustrates a high-level example of a passive IoT device 400B in accordance with various aspects. In general, the passive IoT device 400B shown in FIG. 4B may include various components that are the same and/or substantially similar to the IoT device 400A shown in FIG. 4A, which was described in greater detail above. As such, for brevity and ease of description, various details relating to certain components in the passive IoT device 400B shown in FIG. 4B may be omitted herein to the extent that the same or similar details have already been provided above in relation to the IoT device 400A illustrated in FIG. 4A.

The passive IoT device 400B shown in FIG. 4B may generally differ from the IoT device 400A shown in FIG. 4A in that the passive IoT device 400B may not have a processor, internal memory, or certain other components. Instead, in various embodiments, the passive IoT device 400B may only include an I/O interface 414 or other suitable mechanism that allows the passive IoT device 400B to be observed, monitored, controlled, managed, or otherwise known within a controlled IoT network. For example, in various embodiments, the I/O interface 414 associated with the passive IoT device 400B may include a barcode, Bluetooth interface, radio frequency (RF) interface, RFID tag, IR interface, NFC interface, or any other suitable I/O interface that can provide an identifier and attributes associated with the passive IoT device 400B to another device when queried over a short range interface (e.g., an active IoT device, such as IoT device 400A, that can detect, store, communicate, act on, or otherwise process information relating to the attributes associated with the passive IoT device 400B).

Although the foregoing describes the passive IoT device 400B as having some form of RF, barcode, or other I/O interface 414, the passive IoT device 400B may comprise a device or other physical object that does not have such an I/O interface 414. For example, certain IoT devices may have appropriate scanner or reader mechanisms that can detect shapes, sizes, colors, and/or other observable features associated with the passive IoT device 400B to identify the passive IoT device 400B. In this manner, any suitable physical object may communicate an identity and one or more attributes associated therewith and be observed, monitored, controlled, or otherwise managed within a controlled IoT network.

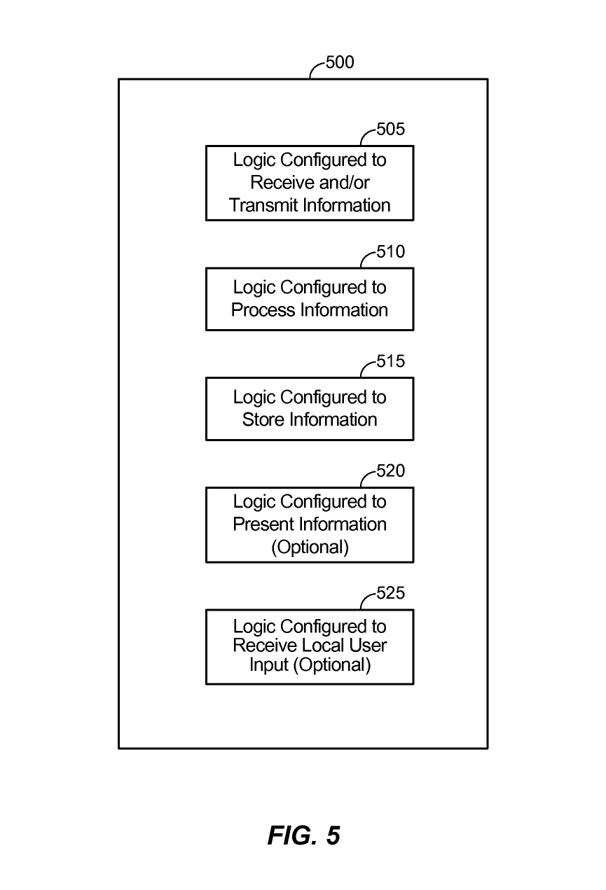

FIG. 5 illustrates a communication device 500 that includes logic configured to perform the functionality disclosed herein. The communication device 500 can correspond to any of the above-noted communication devices, including but not limited to UEs 1 . . . N shown in FIG. 1, IoT devices 210-220 shown in FIG. 2A-2E, communication devices 300A and 300B shown in FIG. 3, IoT devices 400A, 400B shown in FIG. 4A-4B, a component coupled to the Internet (e.g., the application server 170 shown in FIG. 1, the IoT server 270 shown in FIG. 2A-2E), and so on. Thus, communication device 500 can correspond to any electronic device that is configured to communicate with (or facilitate communication with) one or more other entities over the wireless communications systems 100 shown in FIG. 1 and the wireless communication systems 200A-200E shown in FIG. 2A-2E.

Referring to FIG. 5, the communication device 500 includes logic configured to receive and/or transmit information 505. In an example, if the communication device 500 corresponds to a wireless communications device, the logic configured to receive and/or transmit information 505 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 505 can correspond to a wired communications interface (e.g., a serial connection, a USB or Firewire connection, an Ethernet connection through which the Internet can be accessed, etc.). Thus, if the communication device 500 corresponds to some type of network-based server, the logic configured to receive and/or transmit information 505 can correspond to an Ethernet card, in an example, that connects the network-based server to other communication entities via an Ethernet protocol. In a further example, the logic configured to receive and/or transmit information 505 can include sensory or measurement hardware by which the communication device 500 can monitor a local environment associated therewith (e.g., an accelerometer, a temperature sensor, a light sensor, an antenna for monitoring local RF signals, etc.). The logic configured to receive and/or transmit information 505 can also include software that, when executed, permits the associated hardware of the logic configured to receive and/or transmit information 505 to perform reception and/or transmission function(s) associated therewith. However, the logic configured to receive and/or transmit information 505 does not correspond to software alone, and the logic configured to receive and/or transmit information 505 relies at least in part upon hardware to achieve the functionality associated therewith.

Referring to FIG. 5, the communication device 500 further includes logic configured to process information 510. In an example, the logic configured to process information 510 can include at least a processor. Example implementations of the type of processing that can be performed by the logic configured to process information 510 includes but is not limited to performing determinations, establishing connections, making selections between different information options, performing evaluations related to data, interacting with sensors coupled to the communication device 500 to perform measurement operations, converting information from one format to another (e.g., between different protocols such as .wmv to .avi, etc.), and so on. For example, the processor included in the logic configured to process information 510 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 510 can also include software that, when executed, permits the associated hardware of the logic configured to process information 510 to perform the processing function(s) associated therewith. However, the logic configured to process information 510 does not correspond to software alone, and the logic configured to process information 510 relies at least in part upon hardware to achieve the functionality associated therewith.

Referring to FIG. 5, the communication device 500 further includes logic configured to store information 515. In an example, the logic configured to store information 515 can include at least a non-transitory memory and associated hardware (e.g., a memory controller, etc.). For example, the non-transitory memory included in the logic configured to store information 515 can correspond to RAM, flash memory, ROM, erasable programmable ROM (EPROM), EEPROM, registers, hard disk, a removable disk, a CD-ROM, or any other form of storage medium known in the art. The logic configured to store information 515 can also include software that, when executed, permits the associated hardware of the logic configured to store information 515 to perform the storage function(s) associated therewith. However, the logic configured to store information 515 does not correspond to software alone, and the logic configured to store information 515 relies at least in part upon hardware to achieve the functionality associated therewith.

Referring to FIG. 5, the communication device 500 further optionally includes logic configured to present information 520. In an example, the logic configured to present information 520 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 500. For example, if the communication device 500 corresponds to the communication device 300A as shown in FIG. 3, the logic configured to present information 520 can include the display 310A, or if the communication device 500 corresponds to the communication device 300B as shown in FIG. 3, the logic configured to present information 520 can include the touchscreen display 305B. In a further example, the logic configured to present information 520 can be omitted for certain communication devices, such as network communication devices that do not have a local user interface (e.g., network switches or routers, remote servers, etc.). The logic configured to present information 520 can also include software that, when executed, permits the associated hardware of the logic configured to present information 520 to perform the presentation function(s) associated therewith. However, the logic configured to present information 520 does not correspond to software alone, and the logic configured to present information 520 relies at least in part upon hardware to achieve functionality associated therewith.

Referring to FIG. 5, the communication device 500 further optionally includes logic configured to receive local user input 525. In an example, the logic configured to receive local user input 525 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 500. For example, if the communication device 500 corresponds to the communication device 300A as shown in FIG. 3, the logic configured to receive local user input 525 can include the keypad 320A, or if the communication device 500 corresponds to the communication device 300B as shown in FIG. 3, the logic configured to receive local user input 525 can include the peripheral buttons 310B, 315B, 320B and 325B, the front-panel button 330B, and/or the touchscreen display 305B. In a further example, the logic configured to receive local user input 525 can be omitted for certain communication devices, such as network communication devices that do not have a local user (e.g., network switches or routers, remote servers, etc.). The logic configured to receive local user input 525 can also include software that, when executed, permits the associated hardware of the logic configured to receive local user input 525 to perform the input reception function(s) associated therewith. However, the logic configured to receive local user input 525 does not correspond to software alone, and the logic configured to receive local user input 525 relies at least in part upon hardware to achieve the functionality associated therewith.

Referring to FIG. 5, while the configured logics of 505 through 525 are shown as separate or distinct blocks in FIG. 5, those skilled in the art will appreciate that the hardware and/or software by which the respective configured logic performs the functionality associated therewith can overlap in part. For example, any software used to facilitate the functionality of the configured logics of 505 through 525 can be stored in the non-transitory memory associated with the logic configured to store information 515, such that the configured logics of 505 through 525 each performs their functionality (i.e., in this case, software execution) based in part upon the operation of software stored by the logic configured to store information 515. Likewise, hardware that is directly associated with one of the configured logics can be borrowed or used by other configured logics from time to time. For example, the processor of the logic configured to process information 510 can format data into an appropriate format before being transmitted by the logic configured to receive and/or transmit information 505, such that the logic configured to receive and/or transmit information 505 performs the functionality associated therewith (i.e., in this case, transmission of data) based in part upon the operation of hardware (i.e., the processor) associated with the logic configured to process information 510.

Generally, unless stated otherwise explicitly, the phrase “logic configured to” as used herein is intended to refer to logic at least partially implemented with hardware, and is not intended to map to software-only implementations that are independent of hardware. Also, those skilled in the art will appreciate that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear from a review of the aspects described below in more detail.

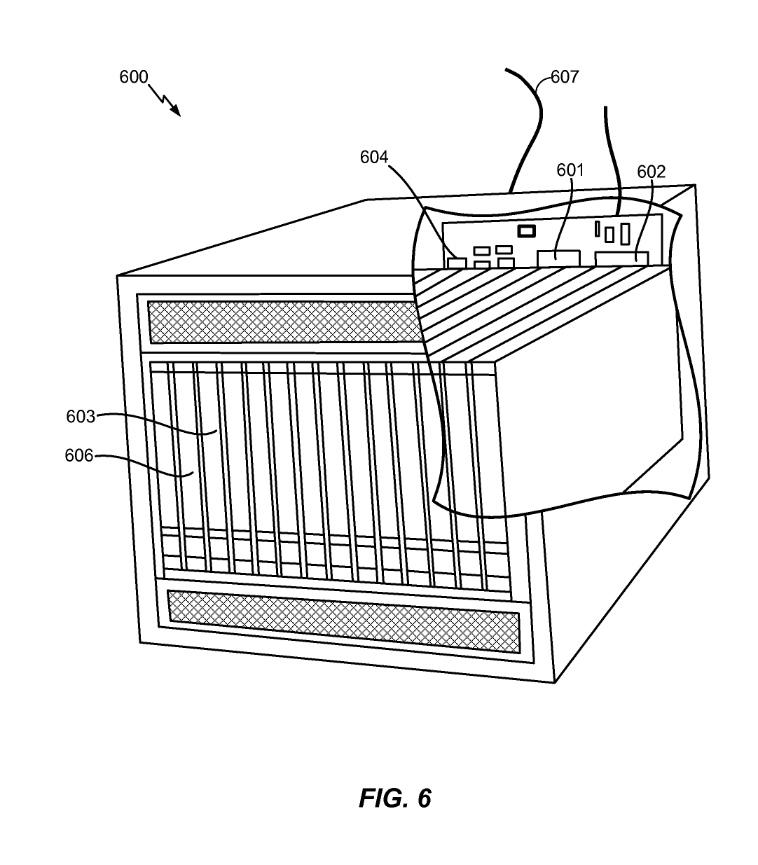

The various embodiments may be implemented on any of a variety of commercially available server devices, such as server 600 illustrated in FIG. 6. In an example, the server 600 may correspond to one example configuration of the application server 170 and/or IoT server 270 described above. In FIG. 6, the server 600 includes a processor 601 coupled to volatile memory 602 and a large capacity nonvolatile memory, such as a disk drive 603. The server 600 may also include a floppy disc drive, compact disc (CD) or DVD disc drive 606 coupled to the processor 601. The server 600 may also include network access ports 604 coupled to the processor 601 for establishing data connections with a network 607, such as a local area network coupled to other broadcast system computers and servers or to the Internet. In context with FIG. 5, those skilled in the art will appreciate that the server 600 shown in FIG. 6 illustrates one example implementation of the communication device 500, whereby the logic configured to receive and/or transmit information 505 corresponds to the network access points 604 used by the server 600 to communicate with the network 607, the logic configured to process information 510 corresponds to the processor 601, and the logic configuration to store information 515 corresponds to any combination of the volatile memory 602, the disk drive 603 and/or the disc drive 606. The optional logic configured to present information 520 and the optional logic configured to receive local user input 525 are not shown explicitly in FIG. 6 and may or may not be included in the server 600 illustrated therein. Thus, FIG. 6 helps to demonstrate that the communication device 500 may be implemented as a server, in addition to a communication device implementation as in FIG. 5.

In general, as noted above, IP based technologies and services have become more mature, driving down the cost and increasing availability of IP, which has allowed Internet connectivity to be added to more and more types of everyday electronic objects. As such, the IoT is based on the idea that everyday electronic objects, not just computers and computer networks, can be readable, recognizable, locatable, addressable, and controllable via the Internet. In general, with the development and increasing prevalence of the IoT, numerous proximate heterogeneous IoT devices and other physical objects that have different types and perform different activities (e.g., lights, printers, refrigerators, air conditioners, etc.) may interact with one another in many different ways and be used in many different ways. As such, due to the potentially large number of heterogeneous IoT devices and other physical objects that may be in use within a controlled IoT network, well-defined and reliable communication interfaces are generally needed to connect the various heterogeneous IoT devices such that the various heterogeneous devices can communicate with one another and exchange information. Accordingly, the following description generally outlines an exemplary communication framework that may support discoverable device-to-device (D2D) or peer-to-peer (P2P) services that can enable direct D2D communication among heterogeneous devices in a distributed programming environment according to the various aspects and embodiments disclosed herein.

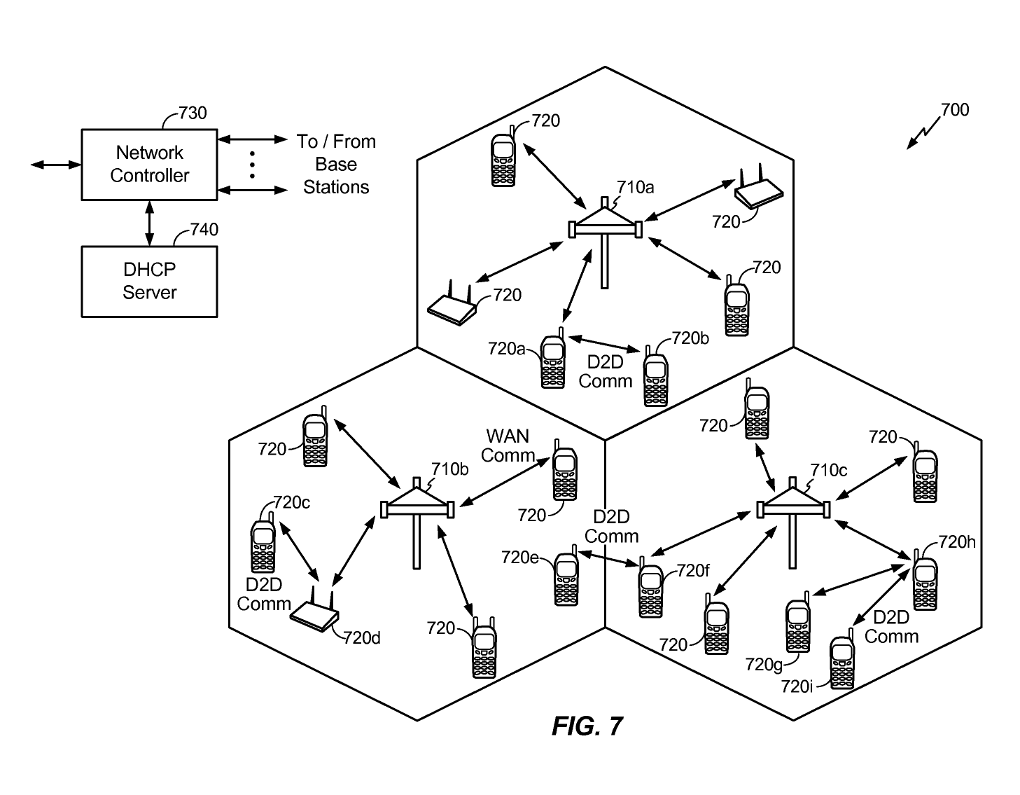

In general, user equipment (UE) (e.g., telephones, tablet computers, laptop and desktop computers, vehicles, etc.), can be configured to connect with one another locally (e.g., Bluetooth, local Wi-Fi, etc.), remotely (e.g., via cellular networks, through the Internet, etc.), or according to suitable combinations thereof. Furthermore, certain UEs may also support proximity-based D2D communication using certain wireless networking technologies (e.g., Wi-Fi, Bluetooth, Wi-Fi Direct, etc.) that support one-to-one connections or simultaneously connections to a group that includes several devices directly communicating with one another. To that end, FIG. 7 illustrates an exemplary wireless communication network or WAN 700 that may support discoverable D2D services that can enable direct D2D communication, wherein the wireless communication network 700 may comprise an LTE network or another suitable WAN that includes various base stations 710 and other network entities. For simplicity, only three base stations 710a, 710b and 710c, one network controller 730, and one Dynamic Host Configuration Protocol (DHCP) server 740 are shown in FIG. 7. A base station 710 may be an entity that communicates with devices 720 and may also be referred to as a Node B, an evolved Node B (eNB), an access point, etc. Each base station 710 may provide communication coverage for a particular geographic area and may support communication for the devices 720 located within the coverage area. To improve network capacity, the overall coverage area of a base station 710 may be partitioned into multiple (e.g., three) smaller areas, wherein each smaller area may be served by a respective base station 710. In 3GPP, the term “cell” can refer to a coverage area of a base station 710 and/or a base station subsystem 710 serving this coverage area, depending on the context in which the term is used. In 3GPP2, the term “sector” or “cell-sector” can refer to a coverage area of a base station 710 and/or a base station subsystem 710 serving this coverage area. For clarity, the 3GPP concept of “cell” may be used in the description herein.

A base station 710 may provide communication coverage for a macro cell, a pico cell, a femto cell, and/or other cell types. A macro cell may cover a relatively large geographic area (e.g., several kilometers in radius) and may allow unrestricted access by devices 720 with service subscription. A pico cell may cover a relatively small geographic area and may allow unrestricted access by devices 720 with service subscription. A femto cell may cover a relatively small geographic area (e.g., a home) and may allow restricted access by devices 720 having association with the femto cell (e.g., devices 720 in a Closed Subscriber Group (CSG)). In the example shown in FIG. 7, wireless network 700 includes macro base stations 710a, 710b and 710c for macro cells. Wireless network 700 may also include pico base stations 710 for pico cells and/or home base stations 710 for femto cells (not shown in FIG. 7).

Network controller 730 may couple to a set of base stations 710 and may provide coordination and control for these base stations 710. Network controller 730 may be a single network entity or a collection of network entities that can communicate with the base stations via a backhaul. The base stations may also communicate with one another (e.g., directly or indirectly via wireless or wireline backhaul). DHCP server 740 may support D2D communication, as described below. DHCP server 740 may be part of wireless network 700, external to wireless network 700, run via Internet Connection Sharing (ICS), or any suitable combination thereof. DHCP server 740 may be a separate entity (e.g., as shown in FIG. 7) or may be part of a base station 710, network controller 730, or some other entity. In any case, DHCP server 740 may be reachable by devices 720 desiring to communicate directly.

Devices 720 may be dispersed throughout wireless network 700, and each device 720 may be stationary or mobile. A device 720 may also be referred to as a node, user equipment (UE), a station, a mobile station, a terminal, an access terminal, a subscriber unit, etc. A device 720 may be a cellular phone, a personal digital assistant (PDA), a wireless modem, a wireless communication device, a handheld device, a laptop computer, a cordless phone, a wireless local loop (WLL) station, a smart phone, a netbook, a smartbook, a tablet, etc. A device 720 may communicate with base stations 710 in the wireless network 700 and may further communicate peer-to-peer with other devices 720. For example, as shown in FIG. 7, devices 720a and 720b may communicate peer-to-peer, devices 720c and 720d may communicate peer-to-peer, devices 720e and 720f may communicate peer-to-peer, and devices 720g, 720h, and 720i may communicate peer-to-peer, while remaining devices 720 may communicate with base stations 710. As further shown in FIG. 7, devices 720a, 720d, 720f, and 720h may also communicate with base stations 700 (e.g., when not engaged in D2D communication, or possibly concurrent with D2D communication).

In the description herein, WAN communication may refer to communication between a device 720 and a base station 710 in wireless network 700 (e.g., for a call with a remote entity such as another device 720). A WAN device is a device 720 that is interested or engaged in WAN communication. In general, the terms “peer-to-peer” or “P2P” communication and “device-to-device” or “D2D” communication as used herein refers to direct communication between two or more devices 720, without going through any base station 710. For simplicity, the description provided herein uses the term “device-to-device” or “D2D” to refer to such direct communication, although those skilled in the art will appreciate that the terms “peer-to-peer,” “P2P,” “device-to-device,” and “D2D” may be interchangeable in the various aspects and embodiments described herein.

According to various embodiments, a D2D device is a device 720 that is interested or engaged in D2D communication (e.g., a device 720 that has traffic data for another device 720 within proximity of the D2D device). Two devices may be considered to be within proximity of one another, for example, if each device 720 can detect the other device 720. In general, a device 720 may communicate with another device 720 either directly for D2D communication or via at least one base station 710 for WAN communication.

In various embodiments, direct communication between D2D devices 720 may be organized into D2D groups. More particularly, a D2D group generally refers to a group of two or more devices 720 interested or engaged in D2D communication and a D2D link refers to a communication link for a D2D group. Furthermore, in various embodiments, a D2D group may include one device 720 designated a D2D group owner (or a D2D server) and one or more devices 720 designated D2D clients that are served by the D2D group owner. The D2D group owner may perform certain management functions such as exchanging signaling with a WAN, coordinating data transmission between the D2D group owner and D2D clients, etc. For example, as shown in FIG. 7, a first D2D group includes devices 720a and 720b under the coverage of base station 710a, a second D2D group includes devices 720c and 720d under the coverage of base station 710b, a third D2D group includes devices 720e and 720f under the coverage of different base stations 710b and 710c, and a fourth D2D group includes devices 720g, 720h and 720i under the coverage of base station 710c. Devices 720a, 720d, 720f, and 720h may be D2D group owners for their respective D2D groups and devices 720b, 720c, 720e, 720g, and 720i may be D2D clients in their respective D2D groups. The other devices 720 in FIG. 7 may be engaged in WAN communication.

In various embodiments, D2D communication may occur only within a D2D group and may further occur only between the D2D group owner and the D2D clients associated therewith. For example, if two D2D clients within the same D2D group (e.g., devices 720g and 720i) desire to exchange information, one of the D2D clients may send the information to the D2D group owner (e.g., device 720h) and the D2D group owner may then relay transmissions to the other D2D client. In various embodiments, a particular device 720 may belong to multiple D2D groups and may behave as either a D2D group owner or a D2D client in each D2D group. Furthermore, in various embodiments, a particular D2D client may belong to only one D2D group or belong to multiple D2D group and communicate with D2D devices 720 in any of the multiple D2D groups at any particular moment. In general, communication may be facilitated via transmissions on the downlink and uplink. For WAN communication, the downlink (or forward link) refers to the communication link from base stations 710 to devices 720, and the uplink (or reverse link) refers to the communication link from devices 720 to base stations 710. For D2D communication, the D2D downlink refers to the communication link from D2D group owners to D2D clients and the D2D uplink refers to the communication link from D2D clients to D2D group owners. In various embodiments, rather than using WAN technologies to communicate D2D, two or more devices may form smaller D2D groups and communicate D2D on a wireless local area network (WLAN) using technologies such as Wi-Fi, Bluetooth, or Wi-Fi Direct. For example, D2D communication using Wi-Fi, Bluetooth, Wi-Fi Direct, or other WLAN technologies may enable D2D communication between two or more mobile phones, game consoles, laptop computers, or other suitable communication entities.

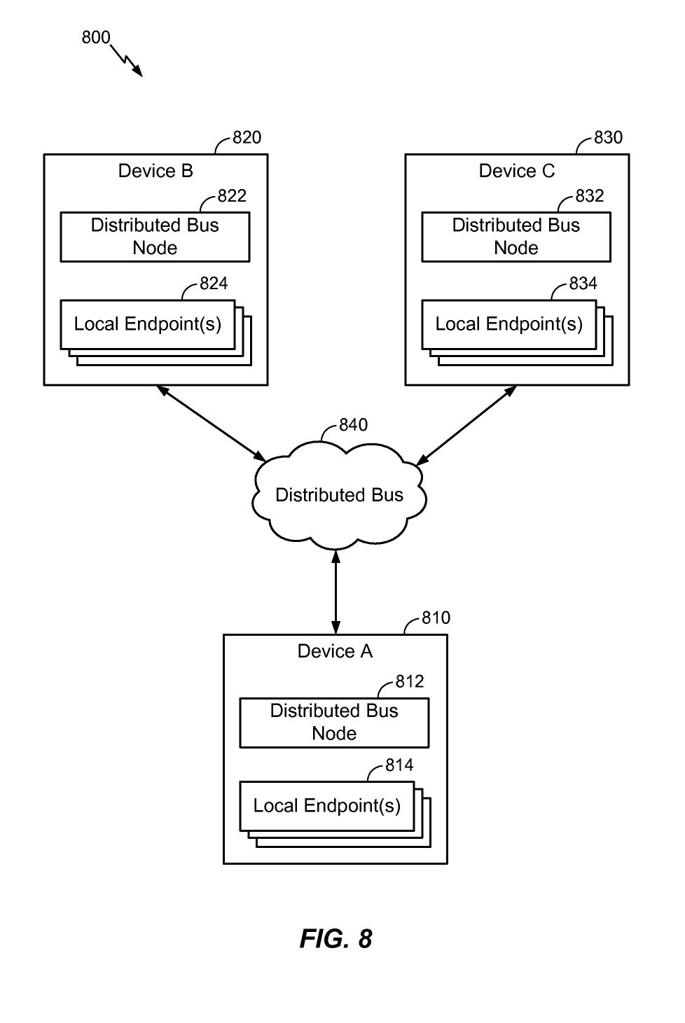

According to various aspects, FIG. 8 illustrates an exemplary environment 800 in which discoverable D2D services may be used to establish a proximity-based distributed bus 840 over which various devices 810, 820, 830 may communicate using D2D technology. For example, in various embodiments, communications between applications and the like, on a single platform may be facilitated using an interprocess communication protocol (IPC) framework over the distributed bus 840, which may comprise a software bus used to enable application-to-application communications in a networked computing environment where applications register with the distributed bus 840 to offer services to other applications and other applications query the distributed bus 840 for information about registered applications. Such a protocol may provide asynchronous notifications and remote procedure calls (RPCs) in which signal messages (e.g., notifications) may be point-to-point or broadcast, method call messages (e.g., RPCs) may be synchronous or asynchronous, and the distributed bus 840 may handle message routing between the various devices 810, 820, 830 (e.g., via one or more bus routers or “daemons” or other suitable processes that may provide attachments to the distributed bus 840).

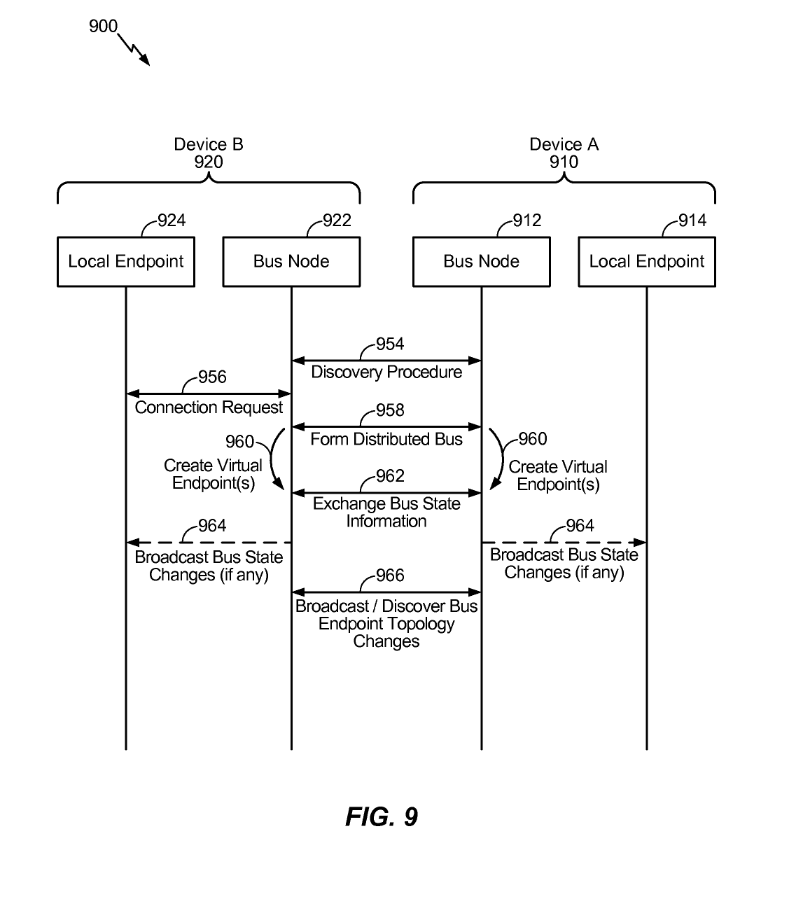

In various embodiments, the distributed bus 840 may be supported by a variety of transport protocols (e.g., Bluetooth, TCP/IP, Wi-Fi, CDMA, GPRS, UMTS, etc.). For example, according to various aspects, a first device 810 may include a distributed bus node 812 and one or more local endpoints 814, wherein the distributed bus node 812 may facilitate communications between local endpoints 814 associated with the first device 810 and local endpoints 824 and 834 associated with a second device 820 and a third device 830 through the distributed bus 840 (e.g., via distributed bus nodes 822 and 832 on the second device 820 and the third device 830). As will be described in further detail below with reference to FIG. 9, the distributed bus 840 may support symmetric multi-device network topologies and may provide a robust operation in the presence of device drops-outs. As such, the virtual distributed bus 840, which may generally be independent from any underlying transport protocol (e.g., Bluetooth, TCP/IP, Wi-Fi, etc.) may allow various security options, from unsecured (e.g., open) to secured (e.g., authenticated and encrypted), wherein the security options can be used while facilitating spontaneous connections among the first device 810, the second device 820, and the third device 830 without intervention when the various devices 810, 820, 830 come into range or proximity to each other.

According to various aspects, FIG. 9 illustrates an exemplary signaling flow 900 in which discoverable D2D services may be used to establish a proximity-based distributed bus over which a first device (“Device A”) 910 and a second device (“Device B”) 920 may communicate using D2D technology. For example, in the signaling flow 900 shown in FIG. 9, Device A 910 may request to communicate with Device B 920, wherein Device A 910 may a include local endpoint 914 (e.g., a local application, service, etc.), which may make a request to communicate in addition to a bus node 912 that may assist in facilitating such communications. Further, Device B 920 may include a local endpoint 924 with which the local endpoint 914 may be attempting to communicate in addition to a bus node 922 that may assist in facilitating communications between the local endpoint 914 on the Device A 910 and the local endpoint 924 on Device B 920.

In various embodiments, the bus nodes 912 and 922 may perform a suitable discovery mechanism at 954. For example, mechanisms for discovering connections supported by Bluetooth, TCP/IP, UNIX, or the like may be used. At 956, the local endpoint 914 on Device A 910 may request to connect to an entity, service, endpoint etc., available through bus node 912. In various embodiments, the request may include a request-and-response process between local endpoint 914 and bus node 912. At 958, a distributed message bus may be formed to connect bus node 912 to bus node 922 and thereby establish a D2D connection between Device A 910 and Device B 920. In various embodiments, communications to form the distributed bus between the bus nodes 912 and 922 may be facilitated using a suitable proximity-based D2D protocol (e.g., the AllJoyn™ software framework designed to enable interoperability among connected products and software applications from different manufacturers to dynamically create proximal networks and facilitate proximal D2D communication). Alternatively, in various embodiments, a server (not shown) may facilitate the connection between the bus nodes 912 and 922. Furthermore, in various embodiments, a suitable authentication mechanism may be used prior to forming the connection between bus nodes 912 and 922 (e.g., SASL authentication in which a client may send an authentication command to initiate an authentication conversation). Still further, at 958, bus nodes 912 and 922 may exchange information about other available endpoints (e.g., local endpoints 834 on Device C 830 in FIG. 8). In such embodiments, each local endpoint that a bus node maintains may be advertised to other bus nodes, wherein the advertisement may include unique endpoint names, transport types, connection parameters, or other suitable information.

In various embodiments, at 960, bus node 912 and bus node 922 may use obtained information associated with the local endpoints 924 and 914, respectively, to create virtual endpoints that may represent the real obtained endpoints available through various bus nodes. In various embodiments, message routing on the bus node 912 may use real and virtual endpoints to deliver messages. Further, there may one local virtual endpoint for every endpoint that exists on remote devices (e.g., Device A 910). Still further, such virtual endpoints may multiplex and/or de-multiplex messages sent over the distributed bus (e.g., a connection between bus node 912 and bus node 922). In various embodiments, virtual endpoints may receive messages from the local bus node 912 or 922, just like real endpoints, and may forward messages over the distributed bus. As such, the virtual endpoints may forward messages to the local bus nodes 912 and 922 from the endpoint multiplexed distributed bus connection. Furthermore, in various embodiments, virtual endpoints that correspond to virtual endpoints on a remote device may be reconnected at any time to accommodate desired topologies of specific transport types. In such embodiments, UNIX based virtual endpoints may be considered local and as such may not be considered candidates for reconnection. Further, TCP-based virtual endpoints may be optimized for one hop routing (e.g., each bus node 912 and 922 may be directly connected to each other). Still further, Bluetooth-based virtual endpoints may be optimized for a single pico-net (e.g., one master and n slaves) in which the Bluetooth-based master may be the same bus node as a local master node.

In various embodiments, the bus node 912 and the bus node 922 may exchange bus state information at 962 to merge bus instances and enable communication over the distributed bus. For example, in various embodiments, the bus state information may include a well-known to unique endpoint name mapping, matching rules, routing group, or other suitable information. In various embodiments, the state information may be communicated between the bus node 912 and the bus node 922 instances using an interface with local endpoints 914 and 924 communicating with using a distributed bus based local name. In another aspect, bus node 912 and bus node 922 may each may maintain a local bus controller responsible for providing feedback to the distributed bus, wherein the bus controller may translate global methods, arguments, signals, and other information into the standards associated with the distributed bus. The bus node 912 and the bus node 922 may communicate (e.g., broadcast) signals at 964 to inform the respective local endpoints 914 and 924 about any changes introduced during bus node connections, such as described above. In various embodiments, new and/or removed global and/or translated names may be indicated with name owner changed signals. Furthermore, global names that may be lost locally (e.g., due to name collisions) may be indicated with name lost signals. Still further, global names that are transferred due to name collisions may be indicated with name owner changed signals and unique names that disappear if and/or when the bus node 912 and the bus node 922 become disconnected may be indicated with name owner changed signals.

As used above, well-known names may be used to uniquely describe local endpoints 914 and 924. In various embodiments, when communications occur between Device A 910 and Device B 920, different well-known name types may be used. For example, a device local name may exist only on the bus node 912 associated with Device A 910 to which the bus node 912 directly attaches. In another example, a global name may exist on all known bus nodes 912 and 922, where only one owner of the name may exist on all bus segments. In other words, when the bus node 912 and bus node 922 are joined and any collisions occur, one of the owners may lose the global name. In still another example, a translated name may be used when a client is connected to other bus nodes associated with a virtual bus. In such embodiments, the translated name may include an appended end (e.g., a local endpoint 914 with well-known name “org.foo” connected to the distributed bus with Globally Unique Identifier “1234” may be seen as “G1234.org.foo”).

In various embodiments, the bus node 912 and the bus node 922 may communicate (e.g., broadcast) signals at 966 to inform other bus nodes of changes to endpoint bus topologies. Thereafter, traffic from local endpoint 914 may move through virtual endpoints to reach intended local endpoint 924 on Device B 920. Further, in operation, communications between local endpoint 914 and local endpoint 924 may use routing groups. In various embodiments, routing groups may enable endpoints to receive signals, method calls, or other suitable information from a subset of endpoints. As such, a routing name may be determined by an application connected to a bus node 912 or 922. For example, a D2D application may use a unique, well-known routing group name built into the application. Further, bus nodes 912 and 922 may support registering and/or de-registering of local endpoints 914 and 924 with routing groups. In various embodiments, routing groups may have no persistence beyond a current bus instance. In another aspect, applications may register for their preferred routing groups each time they connect to the distributed bus. Still further, groups may be open (e.g., any endpoint can join) or closed (e.g., only the creator of the group can modify the group). Yet further, a bus node 912 or 922 may send signals to notify other remote bus nodes or additions, removals, or other changes to routing group endpoints. In such embodiments, the bus node 912 or 922 may send a routing group change signal to other group members whenever a member is added and/or removed from the group. Further, the bus node 912 or 922 may send a routing group change signal to one or more endpoints that disconnect from the distributed bus without the one or more endpoints first removing themselves from the routing group.

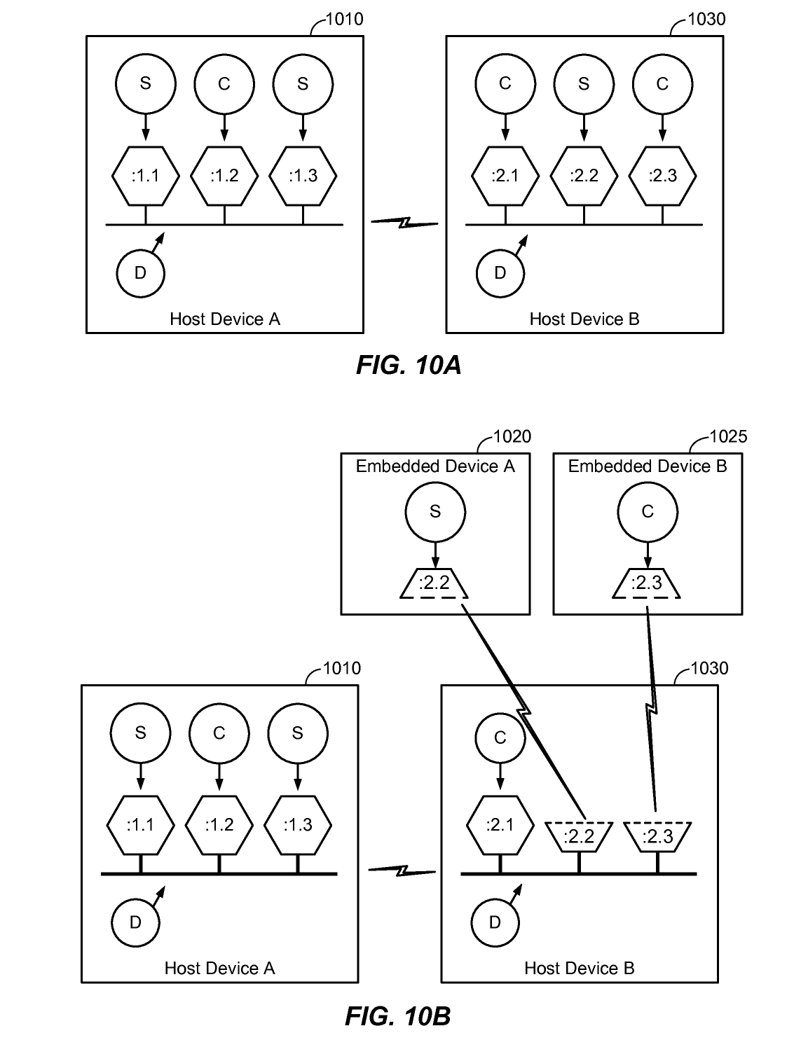

According to various aspects, FIG. 10A illustrates an exemplary proximity-based distributed bus that may be formed between a first host device 1010 and a second host device 1030 to enable D2D communication between the first host device 1010 and the second host device 1030. More particularly, as described above with respect to FIG. 8 and FIG. 9, the basic structure of the proximity-based distributed bus may comprise multiple bus segments that reside on separate physical host devices. Accordingly, in FIG. 10A, each segment of the proximity-based distributed bus may be located on one of the host devices 1010, 1030, wherein the host devices 1010, 1030 may each execute a local bus router (or “daemon”) that may implement the bus segments located on the respective host device 1010, 1030. For example, in FIG. 10A, each host device 1010, 1030 includes a bubble labeled “D” to represent the bus router that implements the bus segments located on the respective host device 1010, 1030. Furthermore, one or more of the host devices 1010, 1030 may have several bus attachments, where each bus attachment connects to the local bus router. For example, in FIG. 10A, the bus attachments on host devices 1010, 1030 are illustrated as hexagons that each correspond to either a service (S) or a client (C) that may request a service (S).

However, in certain cases, embedded devices may lack sufficient resources to run a local bus router. Accordingly, FIG. 10B illustrates an exemplary proximity-based distributed bus in which one or more embedded devices 1020, 1025 can connect to a host device (e.g., host device 1030) to connect to the proximity-based distributed bus and thereby engage in D2D communication (e.g., with the host device 1030 or with other host devices 1010 and/or embedded devices 1025 that are attached to the proximity-based distributed bus via the host device 1030). As such, the embedded devices 1020, 1025 may generally “borrow” the bus router running on the host device 1030, whereby FIG. 10B shows an arrangement where the embedded devices 1020, 1025 are physically separate from the host device 1030 running the borrowed bus router that manages the distributed bus segment on which the embedded devices 1020, 1025 reside. In general, the connection between the embedded devices 1020, 1025 and the host device 1030 may be made according to the Transmission Control Protocol (TCP) and the network traffic flowing between the embedded devices 1020, 1025 and the host device 1030 may comprise messages that implement bus methods, bus signals, and properties flowing over respective sessions in a similar manner to that described above with respect to FIG. 8 and FIG. 9.

More particularly, the embedded devices 1020, 1025 may connect to the host device 1030 according to a discovery and connection process that may be conceptually similar to the discovery and connection process between clients and services, wherein the host device 1030 may advertise a well-known name (e.g., “org.alljoyn.BusNode”) that signals an ability or willingness to host the embedded devices 1020, 1025. In one use case, the embedded devices 1020, 1025 may simply connect to the “first” host device that advertises the well-known name. However, if the embedded devices 1020, 1025 were to simply connect to the first host device that advertises the well-known name, the embedded devices 1020, 1025 may not have any knowledge about the type associated with the host device (e.g., whether the host device 1030 is a mobile device, a set-top box, an access point, etc.), nor would the embedded devices 1020, 1025 have any knowledge about the load status on the host device. Accordingly, in other use cases, the embedded devices 1020, 1025 may adaptively connect to the host device 1030 based on information that the host devices 1010, 1030 provide when advertising the ability or willingness to host other devices (e.g., embedded devices 1020, 1025), which may thereby join the proximity-based distributed bus according to properties associated with the host devices 1010, 1030 (e.g., type, load status, etc.) and/or requirements associated with the embedded devices 1020, 1025 (e.g., a ranking table that expresses a preference to connect to a host device from the same manufacturer).

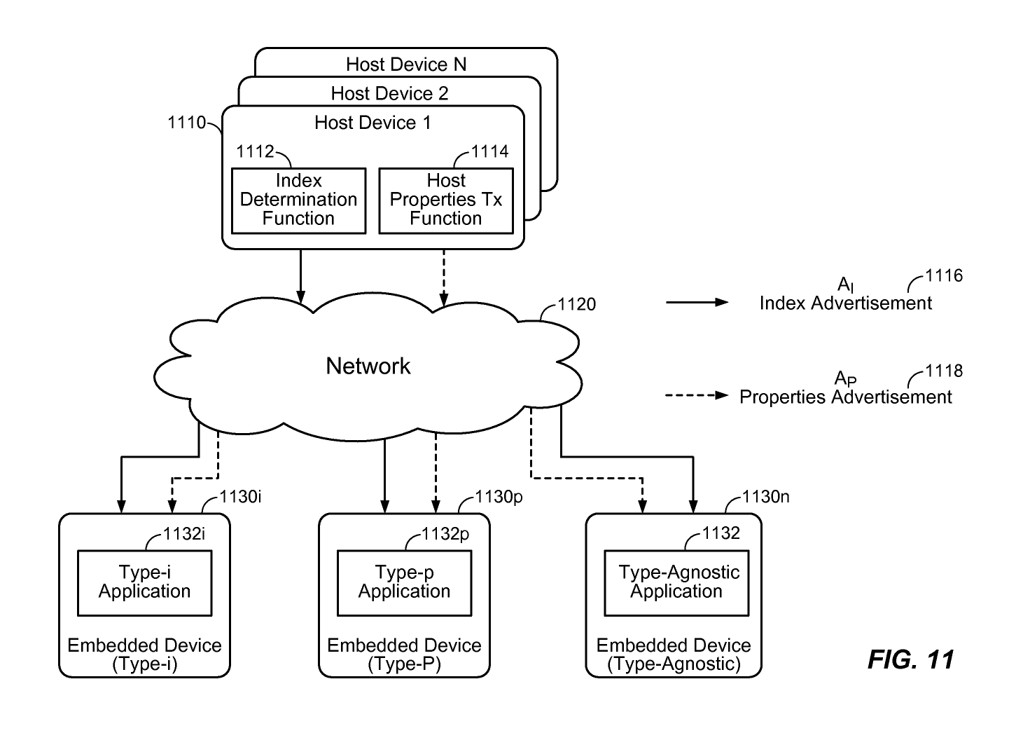

More particularly, according to various aspects, FIG. 11 illustrates exemplary high-level operation in which adaptive advertisements 1116, 1118 may be used to connect embedded devices 1130i, 1130p, 1130n, etc. to a proximity-based distributed bus. In general, each host device 1110 may include an index determination function 1110 and a host properties transmission (Tx) function 1114 that may be used to prepare and transmit advertisements 1116, 1118 that have different types. For example, in one embodiment, the advertisements that each host device 1110 prepares and transmits may include a properties (type-p) advertisement 1118 that indicates one or more properties associated with the host device 1110 (e.g., power source, mobility pattern, network persistency, manufacturer, etc.) and an index (type-i) advertisement 1116 that may apply a weighting factor to each property to eventually derive an index. Accordingly, each embedded device 1130 may run a type-p client application 1132p, a type-i client application 1132i, or a type-agnostic client application 1132. For example, as shown in FIG. 11, an embedded device 1130p may run the type-p client application 1132p to support processing type-p advertisements 1118 such that the embedded device 1130p can connect to a particular host device 1110 according to a decision tree that may filter and/or prioritize the type-p advertisements 1118 while ignoring type-i advertisements 1116. In contrast, an embedded device 1130i may run the type-i client application 1132i to support processing type-i advertisements 1116 such that the embedded device 1130i can connect to a particular host device 1110 having the highest index among all received type-i advertisements 1116 while ignoring type-p advertisements 1118.

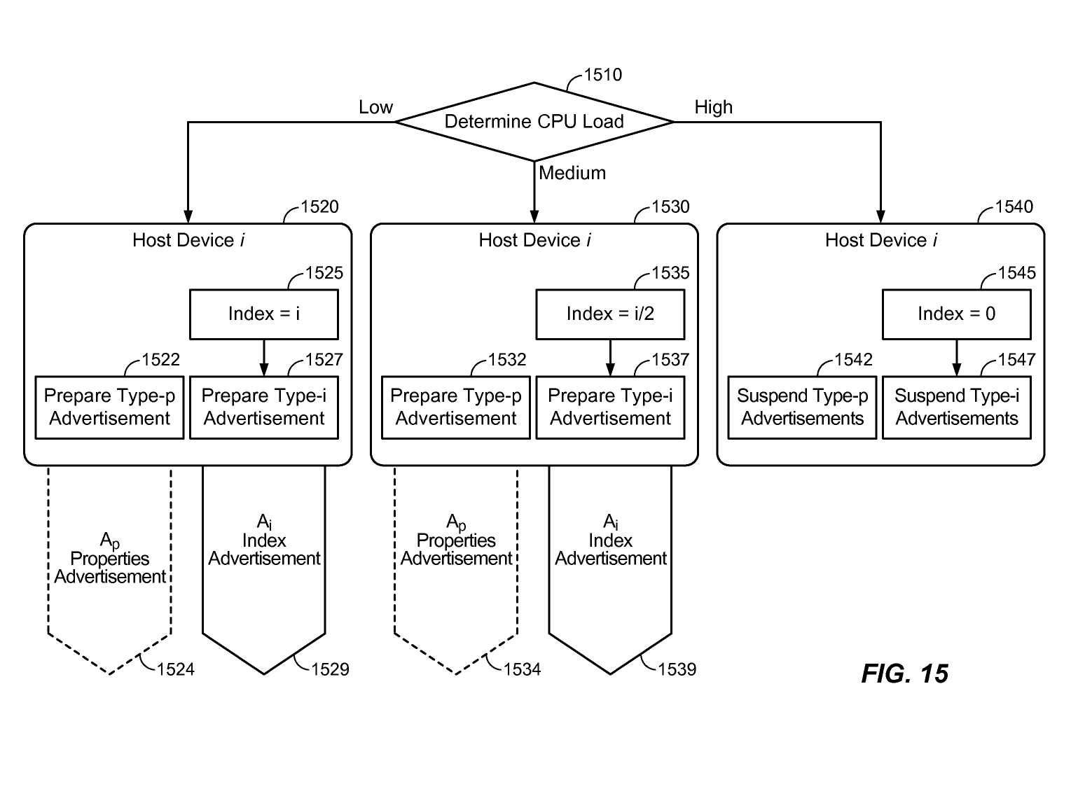

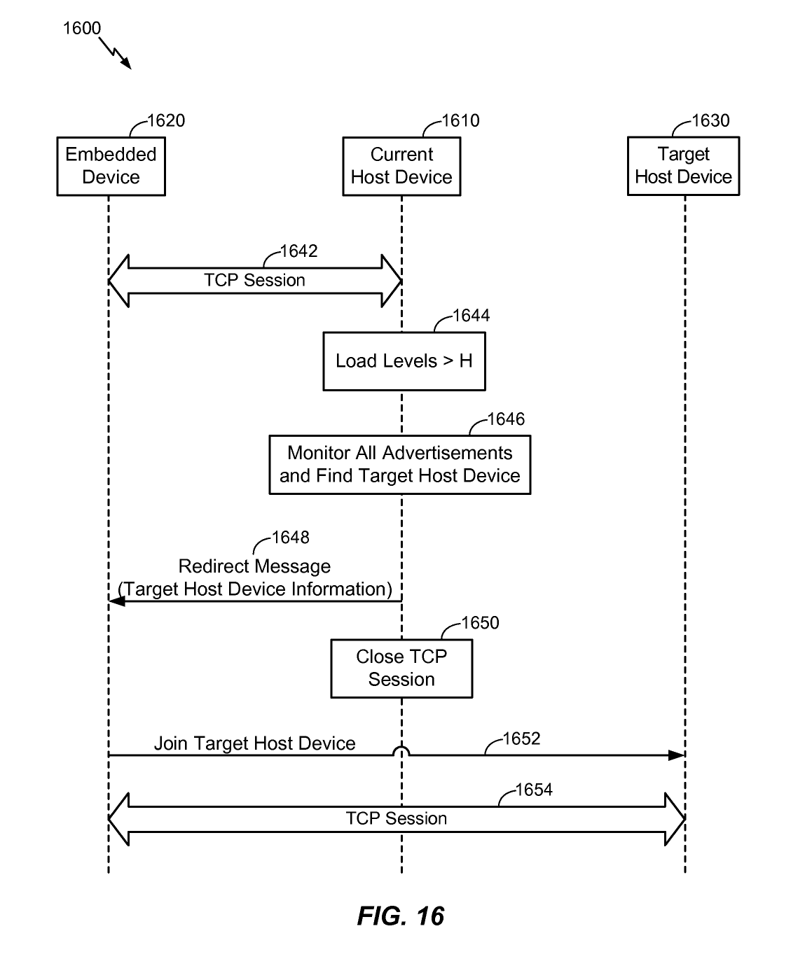

Furthermore, in various embodiments, an embedded device 1130n that runs the type-agnostic client application 1132 may process type-i advertisements 1116 and/or type-p advertisements 1118 and connect to a particular host device 1110 according to the decision tree used to filter and/or prioritize the type-p advertisements 1118 and/or a particular host device 1110 having the highest index among all received type-i advertisements 1116 depending on the particular properties associated with the host device(s) 1110 and/or requirements associated with the embedded device 1130n. Further still, in use cases where one or more of the embedded devices 1130 arrive on the network 1120 after one or more host devices 1110 or other routing nodes, the embedded device(s) 1130 may broadcast a query with a payload that indicates the type associated therewith and the host devices 1110 may only transmit advertisements 1116, 1118 that match the supported type in response to the broadcasted query from the embedded device(s) 1130. As such, the embedded device(s) 1130 may then process the transmitted advertisement(s) 1116 and/or 1118 in substantially the same manner as when both advertisement types 1116, 1118 are received (e.g., when the host device(s) 1110 arrives on the network 1120 after the embedded device(s) 1130). Furthermore, as will be described in further detail below with respect to FIG. 15 and FIG. 16, each host device 1110 may have an overload threshold that determines whether or not the host device 1110 should be “discoverable,” whereby the overload threshold may control whether or not the host device 1110 actively advertises a willingness to host an embedded device 1130 (e.g., the overload threshold may depend on processing power, memory, or other constraints on the host device(s) 1110 such that the host device(s) 1110 stop advertising when the overload threshold has been reached).

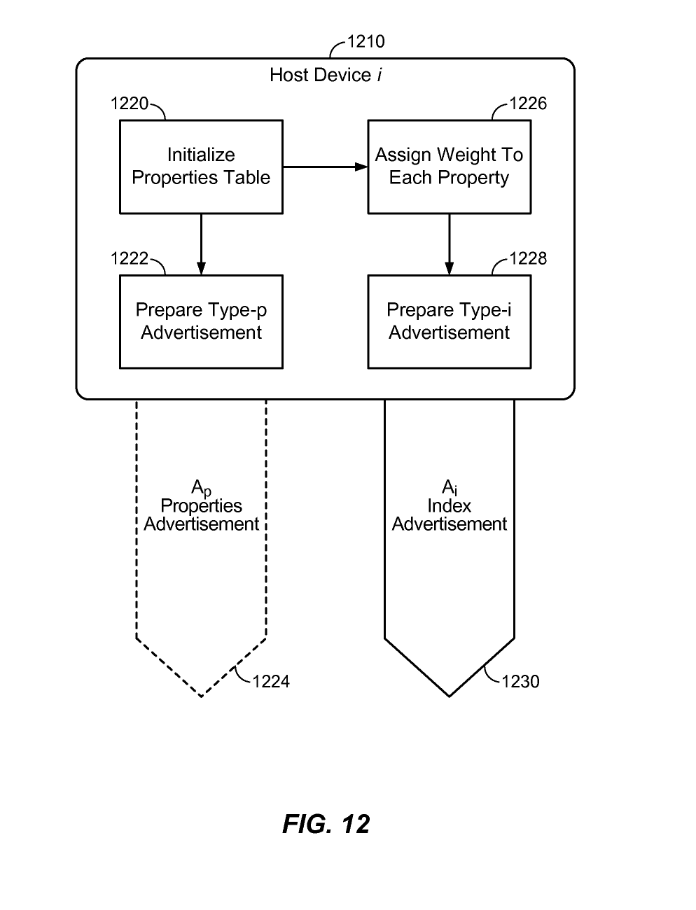

According to various aspects, FIG. 12 illustrates an exemplary host device 1210 that may prepare and transmit advertisements 1224, 1230 to allow one or more embedded devices (not shown) to connect to a proximity-based distributed bus. For example, the host device shown in FIG. 12 may generally include a module 1220 that can be used to initialize a properties table with various properties associated with the host device 1210. As such, in various embodiments, a type-p advertisement module 1222 may use the initialized properties table to prepare the type-p advertisement 1224, which may then be broadcasted or otherwise transmitted to advertise a willingness to host one or more embedded devices that support processing the type-p advertisement 1224. Furthermore, the host device 1210 may include a weighting module 1226 that may apply a weighting factor to each property in the initialized properties table and derive an index therefrom. Accordingly, a type-i advertisement module 1228 may use the index derived from the weights applied to each property to prepare the type-i advertisement 1230, which may then be broadcasted or otherwise transmitted to advertise a willingness to host one or more embedded devices that support processing the type-i advertisement 1230.

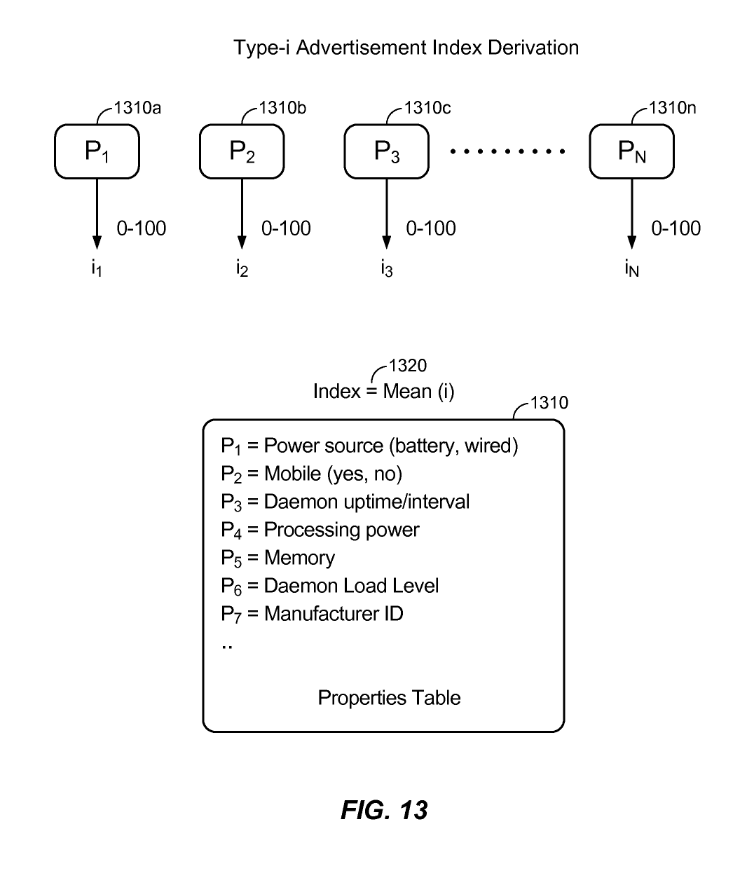

For example, FIG. 13 illustrates exemplary processing to derive an index 1320 used in a type-i advertisement from various properties contained in a properties table 1310. In particular, the properties table 1310 may include various properties 1310a, 1310b, 1310c, 1310n, etc. that are normalized or otherwise scaled according to a suitable range (e.g., to a value between zero (0) and one-hundred (100) in the illustrated example). The scaled values associated with the various properties 1310a, 1310b, 1310c, 1310n, etc. may then be averaged to derive a mean property value that corresponds to the index 1320 communicated in the type-i advertisement. In the example shown in FIG. 13, the various properties included in the properties table 1310 may include a power source property (e.g., battery or wired), a mobile property (e.g., yes or no), an uptime/interval property, a processing power property, a memory property, a load level property, a manufacturer identifier property, and so on. Accordingly, in one example, the host device may scale the load level property through periodically determining a processing load associated therewith and updating the corresponding value in the properties table 1310 accordingly. For example, in one embodiment, the overload threshold may map to one-hundred and an idle load may map to zero such that the current load may have a value in the 0-100 range based on the idle load and overload threshold values, whereby the scaled value input to the index derivation function may map 1:1 to the load level property. In another example, to scale the processing power property, the host device may map the processing power in a range between 0.1 GHZ to 10 GHZ according to 0.1 GHZ increments such that the processing power may have a discrete value in the allowed range, which may be divided by 0.1 (or multiplied by 10) to result in a value within the 0-100 scale that maps 1:1 to the index 1320 derived therefrom.

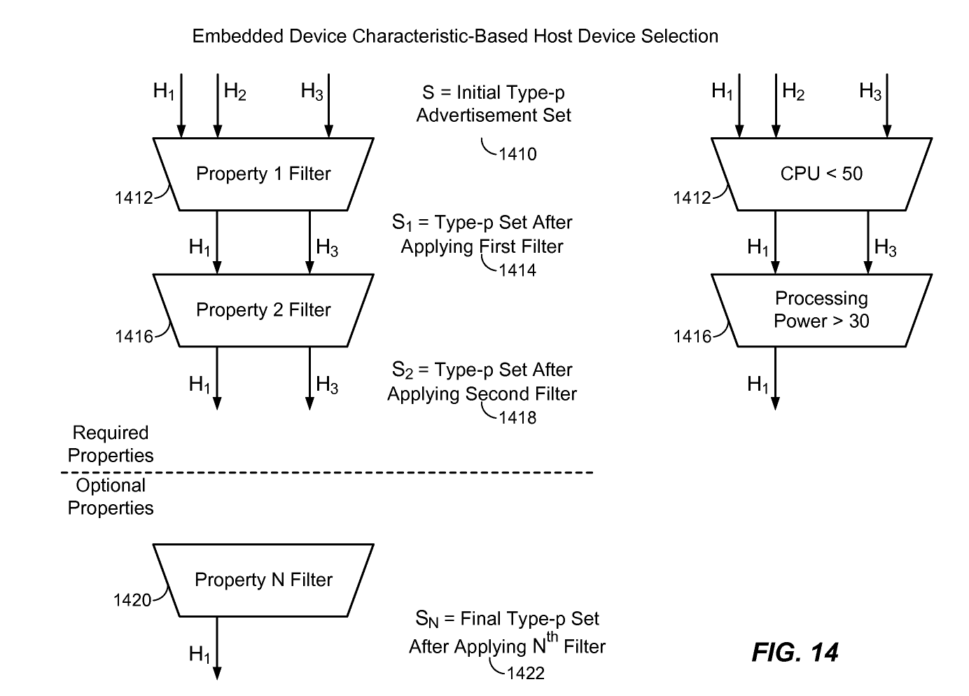

Accordingly, as noted above, an embedded device running a type-i client application may simply select a particular host device having the highest index among all received type-i advertisements, whereas an embedded device running type-p client application may connect to a particular host device according to a decision tree that may be used to filter or otherwise prioritize type-p advertisements that are received from one or more host devices. In the latter context, FIG. 14 illustrates exemplary processing in which a type-p client application may process type-p advertisements according to the decision tree. For example, FIG. 14 shows a use case where an embedded device receives three type-p advertisements from three respective advertising host devices, wherein the three type-p advertisements are labelled H₁, H₂, and H₃. As such, an input to the decision tree may include an initial type-p advertisement set S 1410, which may be provided to a first property filter 1412 that specifies a requirement that the load level property have a value under fifty (50). Accordingly, assuming that the type-p advertisement H₂ has a value greater than or equal to 50, a type-p advertisement set S₁ 1414 that results from the decision tree applying the first property filter 1412 may only include the type-p advertisements H₁ and H₃. The decision tree may then subject the type-p advertisement set S₁ 1414 to a second property filter 1416, which may require that the processing power property have a value greater than thirty (30). Accordingly, assuming that the type-p advertisement H₃ has a value less than or equal to 30, a resulting type-p advertisement set S₂ 1418 after applying the second property filter 1416 may only include the type-p advertisement H₁, which the embedded device may then select and use to connect to the proximity-based distributed bus. Alternatively, in one embodiment, the decision tree that the type-p client application uses to process the type-p advertisements may implement one or more optional property filters 1420 in addition to the required property filters 1412, 1416 such that the optimal host device may be selected (e.g., when the set S₂ 1418 includes multiple type-p advertisements after all required filters 1412, 1416 defined in the decision tree have been applied).

According to one aspect of the disclosure, FIG. 15 illustrates an exemplary method in which a host device may dynamically adjust advertisements according to load. For example, as noted above, each host device may have an overload threshold that determines whether or not the host device should be “discoverable” and thereby controls whether or not the host device actively advertises a willingness to host an embedded device (e.g., the overload threshold may depend on processing power, memory, or other constraints on the host device such that the host device stops advertising when the overload threshold has been reached). Accordingly, at block 1510, the host device may generally determine a current load associated therewith and then determine whether the current load is “low,” “medium,” or “high” (e.g., based on the scaled property value). For example, in response to determining that the current load is low, the host device may proceed in the normal manner at block 1520, where a type-p advertisement may be prepared at block 1522 and transmitted at 1524 and an index may be derived from the various properties included in the type-p advertisement at block 1525 prior to preparing the type-i advertisement at block 1525 and transmitting the type-i advertisement 1529 (e.g., as described above with respect to FIG. 13, where the index determined at block 1525 and used to prepare the type-i advertisement at block 1527 represents the mean value associated with the properties included in the type-p advertisement). Alternatively, in response to determining at block 1510 that the current load is medium, the host device may prepare the type-p and type-i advertisements at block 1530 in a slightly different manner. More particularly, the type-p advertisement prepared at block 1532 may similarly include the relevant properties from the properties table, which may be transmitted at 1534. However, at block 1535, the host device may scale the mean index to reduce a likelihood that the host device will have the highest index among all advertising host devices. For example, in one embodiment, the host device may divide the mean index by two or another suitable factor at block 1535 prior to preparing the type-i advertisement at block 1537 and transmitting the type-i advertisement at 1539. As such, scaling the mean index may essentially reduce the index value when the current load is medium to increase the chances that embedded devices processing the type-i advertisements that are transmitted at 1539 will connect to a different host device. Furthermore, in response to determining at block 1510 that the current load is high, the host device may suspend transmitting the type-p advertisements at block 1542, arbitrarily set the property index to zero at block 1545, and further suspend transmitting the type-i advertisements at block 1547 to prevent any further embedded devices from connecting thereto when the current load is high.

According to one aspect of the disclosure, FIG. 16 illustrates an exemplary call flow 1600 in which an embedded device 1620 may be connected to a current host device 1610 that may then perform load shedding to connect the embedded device 1620 to another target host device 1630, which may generally occur when the current host device 1610 has a current load that exceeds an overload threshold (e.g., a threshold value above that which may be considered a “high” load in the sense of FIG. 15). In other words, whereas the host device 1610 may suspend advertisements to prevent any further embedded devices 1620 from connecting thereto when the current load is high, the current host device 1610 may take active steps to shed connected embedded devices 1620 when the current load is so high that the current host device 1610 is “overloaded.” Accordingly, at 1642, one or more embedded devices 1620 may initially establish a TCP session with the current host device 1610. The host device 1610 may then monitor a current load associated therewith and determine at 1644 that the current load exceeds the overload threshold. In various embodiments, at 1646, the host device 1610 may monitor all advertisements to find an appropriate target host device 1630 in response to determining that the current load exceeds the overload threshold. As such, at 1648, the current host device 1610 with a current load that exceeds the overload threshold may transmit a redirection message to one or more connected embedded devices 1620 after having found an appropriate target host device 1630, wherein the redirection message may include information that identifies the target host device 1630 and indicates that the current load at the current host device 1610 exceeds the overload threshold. In various embodiments, at 1650, the host device 1610 may close the TCP connection with the connected embedded device(s) 1620, and the embedded device(s) 1620 that received the redirect message may then join the target host device 1630 identified in the redirect message at 1652. The embedded device(s) 1620 may then communicate over the proximity-based distributed bus at 1654 over a TCP connection established with the target host device 1630.

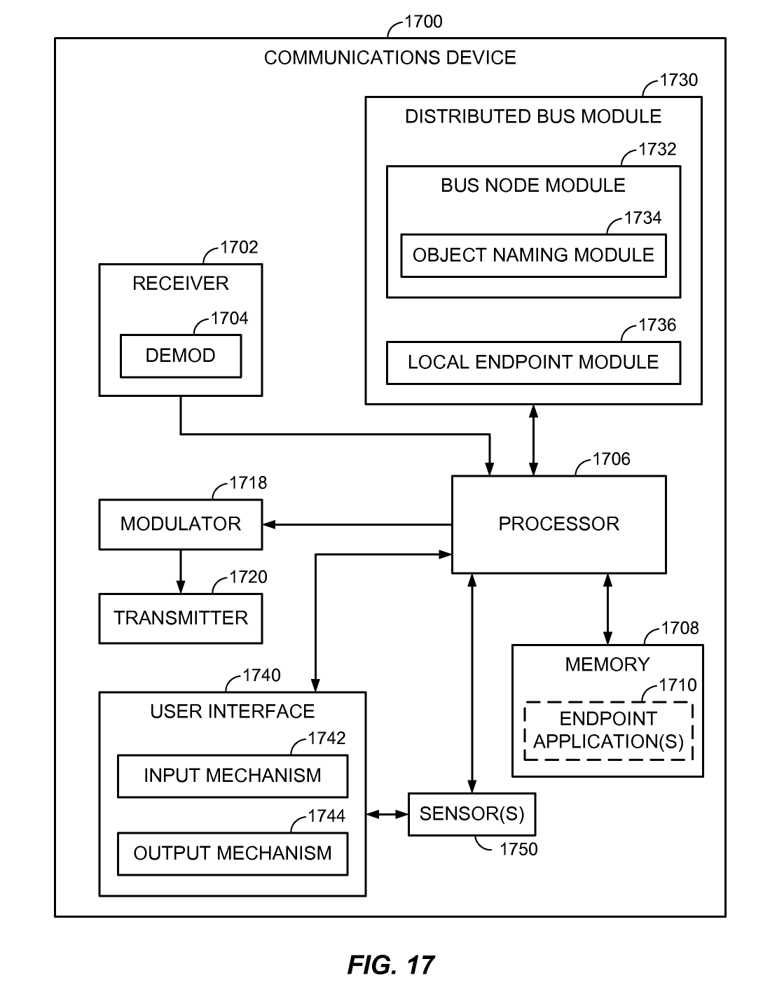

According to one aspect of the disclosure, FIG. 17 illustrates an exemplary communications device 1700 that may support direct D2D communication with other proximal devices in accordance with the various aspects and embodiments disclosed herein, whereby the communications device 1700 may correspond to the host devices and/or the embedded devices used in connection with the various aspects and embodiments described in further detail above. In particular, as shown in FIG. 17, communications device 1700 may comprise a receiver 1702 that may receive a signal from, for instance, a receive antenna (not shown), perform typical actions on the received signal (e.g., filtering, amplifying, downconverting, etc.), and digitize the conditioned signal to obtain samples. The receiver 1702 can comprise a demodulator 1704 that can demodulate received symbols and provide them to a processor 1706 for channel estimation. The processor 1706 can be a processor dedicated to analyzing information received by the receiver 1702 and/or generating information for transmission by a transmitter 1720, controlling one or more components of the communications device 1700, and/or any suitable combination thereof.

In various embodiments, the communications device 1700 can additionally comprise a memory 1708 operatively coupled to the processor 1706, wherein the memory 1708 can store received data, data to be transmitted, information related to available channels, data associated with analyzed signal and/or interference strength, information related to an assigned channel, power, rate, or the like, and any other suitable information for estimating a channel and communicating via the channel. In one aspect, the memory 1708 can include one or more local endpoint applications 1710, which may seek to communicate with endpoint applications, services, etc., on the communications device 1700 and/or other communications devices (not shown) through a distributed bus module 1730. The memory 1708 can additionally store protocols and/or algorithms associated with estimating and/or utilizing a channel (e.g., performance based, capacity based, etc.).

Those skilled in the art will appreciate that the memory 1708 and/or other data stores described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1708 in the subject systems and methods may comprise, without being limited to, these and any other suitable types of memory.

In various embodiments, the distributed bus module 1730 associated with the communications device 1700 can further facilitate establishing connections with other devices. The distributed bus module 1730 may further comprise a bus node module 1732 to assist the distributed bus module 1730 with managing communications between multiple devices. In one aspect, the bus node module 1732 may further include an object naming module 1734 to assist the bus node module 1732 in communicating with endpoint applications associated with other devices. Still further, the distributed bus module 1730 may include an endpoint module 1736 to assist the local endpoint applications 1710 in communicating with other local endpoints and/or endpoint applications accessible on other devices through an established distributed bus. In another aspect, the distributed bus module 1730 may facilitate inter-device and/or intra-device communications over multiple available transports (e.g., Bluetooth, UNIX domain-sockets, TCP/IP, Wi-Fi, etc.). Accordingly, in one embodiment, the distributed bus module 1730 and the endpoint applications 1710 may be used to establish and/or join a proximity-based distributed bus over which the communication device 1700 can communicate with other communication devices in proximity thereto using direct device-to-device (D2D) communication. For example, if the communications device 1700 corresponds to a host device as described herein, the distributed bus module 1732 may manage the segment of the distributed bus hosted on the communications device 1700. However, if the communications device 1700 corresponds to an embedded device as described herein, the distributed bus module 1732 may connect to another host device to attach to the segment of the distributed bus hosted thereon, in which case the communications device 1700 may not include the bus node module 1732, the local endpoint module 1736, and/or not implement certain functionality that the bus node module 1732 and/or the local endpoint module 1736 would otherwise provide in a host device having more substantial resources.

Additionally, in one embodiment, the communications device 1700 may include a user interface 1740, which may include an input mechanism 1742 for generating inputs into the communications device 1700, and an output mechanism 1744 for generating information for consumption by the user of the communications device 1700. For example, the input mechanism 1742 may include one or more mechanisms such as a key or keyboard, a mouse, a touch-screen display, a microphone, etc. Further, for example, the output mechanism 1744 may include a display, an audio speaker, a haptic feedback mechanism, a Personal Area Network (PAN) transceiver etc. In the illustrated aspects, the output mechanism 1744 may include an audio speaker operable to render media content in an audio form, a display operable to render media content in an image or video format and/or timed metadata in a textual or visual form, or other suitable output mechanisms. However, in one embodiment, a headless communications device 1700 may not include certain input mechanisms 1742 and/or output mechanisms 1744 because headless devices generally refer to computer systems or device that have been configured to operate without a monitor, keyboard, and/or mouse.

Furthermore, in various embodiments, the communications device 1700 may include one or more sensors 1750 that can obtain various measurements relating to a local environment associated with the communications device 1700. For example, in various embodiments, the sensors 1750 may include an accelerometer, gyroscope, or other suitable sensors that can obtain measurements that relate to inflicted motion at the communications device 1700. In another example, the sensors 1750 may include appropriate hardware, circuitry, or other suitable devices that can obtain measurements relating to internal and/or ambient temperature, power consumption, local radio signals, lighting, and/or other local and/or ambient environmental variables.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, those skilled in the art will appreciate that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for adaptive advertisement discovery and selection, comprising:
receiving one or more advertisements from one or more host devices;
selecting a host device based on information included in the one or more advertisements; and
connecting to the selected host device to join a proximity-based distributed bus.

2. The method recited in claim 1, wherein the one or more advertisements each include one or more properties associated with the respective host device.

3. The method recited in claim 2, wherein the host device is selected based on a decision tree that filters the one or more properties associated with each host device.

4. The method recited in claim 2, wherein the one or more advertisements further include an index derived from one or more weighting factors applied to the one or more properties associated with the respective host device.

5. The method recited in claim 4, wherein the host device is selected based on which host device has a highest index.

6. The method recited in claim 1, wherein receiving the one or more advertisements from the one or more host devices comprises:
receiving one or more advertisements having a first type and one or more advertisements having a second type in an unsolicited mode; and
receiving one or more requested advertisements that have either the first type or the second type in a solicited mode, wherein the one or more advertisements having the first type each include one or more properties associated with the respective host device, and wherein the one or more advertisements having the second type each include an index derived from one or more weighting factors applied to the one or more properties associated with the respective host device.

7. The method recited in claim 6, wherein one or more of the advertisements having the first type or the advertisements having the second type are dynamically adjusted at the one or more host devices based on current loads at the one or more host devices.

8. The method recited in claim 1, further comprising:
receiving a redirection message from the selected host device, wherein the redirection message includes information that identifies a target host device and indicates that a current load at the selected host device exceeds an overload threshold; and
connecting to the target host device identified in the redirection message.

9. An embedded device, comprising:
a receiver configured to receive one or more advertisements from one or more host devices; and
one or more processors configured to select a host device based on information included in the one or more advertisements and connect to the selected host device to join a proximity-based distributed bus.

10. The embedded device recited in claim 9, wherein the one or more advertisements each include one or more properties associated with the respective host device.

11. The embedded device recited in claim 10, wherein the one or more processors are configured to use a decision tree to filter the one or more properties associated with each host device and select the host device based on the one or more filtered properties.

12. The embedded device recited in claim 10, wherein the one or more advertisements further include an index derived from one or more weighting factors applied to the one or more properties associated with the respective host device.

13. The embedded device recited in claim 12, wherein the one or more processors are configured to select the host device based on the selected host device having a highest index.

14. The embedded device recited in claim 9, wherein the receiver is further configured to:
receive one or more advertisements having a first type and one or more advertisements having a second type in an unsolicited mode; and
receive one or more requested advertisements that have either the first type or the second type in a solicited mode, wherein the one or more advertisements having the first type each include one or more properties associated with the respective host device, and wherein the one or more advertisements having the second type each include an index derived from one or more weighting factors applied to the one or more properties associated with the respective host device.

15. The embedded device recited in claim 14, wherein one or more of the advertisements having the first type or the advertisements having the second type are dynamically adjusted at the one or more host devices based on current loads at the one or more host devices.

16. The embedded device recited in claim 9, wherein:
the receiver is further configured to receive a redirection message from the selected host device, wherein the redirection message includes information that identifies a target host device and indicates that a current load at the selected host device exceeds an overload threshold; and
the one or more processors are further configured to connect to the target host device identified in the redirection message.

17. An apparatus, comprising:
means for receiving one or more advertisements from one or more host devices;
means for selecting a host device based on information included in the one or more advertisements; and
means for connecting to the selected host device to join a proximity-based distributed bus.

18. The apparatus recited in claim 17, wherein the one or more advertisements each include one or more properties associated with the respective host device.

19. The apparatus recited in claim 18, further comprising:
means for filtering the one or more properties associated with each host device according to a decision tree, wherein the means for selecting is further configured for selecting the host device based on the one or more filtered properties associated with each host device.

20. The apparatus recited in claim 17, further comprising:
means for applying one or more weighting factors to the one or more properties associated with the respective host device to derive an index associated with each advertisement, wherein the means for selecting is further configured for selecting the host device based on the selected host device having a highest index.

21. The apparatus recited in claim 17, wherein the means for receiving the advertisements from the one or more host devices comprises:
means for receiving one or more advertisements having a first type and one or more advertisements having a second type in an unsolicited mode; and
means for receiving one or more requested advertisements that have either the first type or the second type in a solicited mode, wherein the one or more advertisements having the first type each include one or more properties associated with the respective host device, and wherein the one or more advertisements having the second type each include an index derived from one or more weighting factors applied to the one or more properties associated with the respective host device.

22. The apparatus recited in claim 21, wherein one or more of the advertisements having the first type or the advertisements having the second type are dynamically adjusted at the one or more host devices based on current loads at the one or more host devices.

23. The apparatus recited in claim 17, further comprising:
means for receiving a redirection message from the selected host device, wherein the redirection message includes information that identifies a target host device and indicates that a current load at the selected host device exceeds an overload threshold; and
means for connecting to the target host device identified in the redirection message.

24. A computer-readable storage medium having computer-executable instructions recorded thereon, wherein executing the computer-executable instructions on an embedded device having one or more processors causes the one or more processors to:
receive one or more advertisements from one or more host devices;
select a host device based on information included in the one or more advertisements; and
connect to the selected host device to join a proximity-based distributed bus.

25. The computer-readable storage medium recited in claim 24, wherein the one or more advertisements each include one or more properties associated with the respective host device.

26. The computer-readable storage medium recited in claim 25, wherein executing the computer-executable instructions on the embedded device further causes the one or more processors to filter the one or more properties associated with each host device according to a decision tree and select the host device based on the one or more filtered properties associated with each host device.

27. The computer-readable storage medium recited in claim 24, wherein executing the computer-executable instructions on the embedded device further causes the one or more processors to apply one or more weighting factors to the one or more properties associated with the respective host device to derive an index associated with each advertisement and select the host device based on the selected host device having a highest index.

28. The computer-readable storage medium recited in claim 24, wherein executing the computer-executable instructions on the embedded device further causes the one or more processors to:
receive one or more advertisements having a first type and one or more advertisements having a second type in an unsolicited mode; and
receive one or more requested advertisements that have either the first type or the second type in a solicited mode, wherein the one or more advertisements having the first type each include one or more properties associated with the respective host device, and wherein the one or more advertisements having the second type each include an index derived from one or more weighting factors applied to the one or more properties associated with the respective host device.

29. The computer-readable storage medium recited in claim 28, wherein one or more of the advertisements having the first type or the advertisements having the second type are dynamically adjusted at the one or more host devices based on current loads at the one or more host devices.

30. The computer-readable storage medium recited in claim 24, wherein executing the computer-executable instructions on the embedded device further causes the one or more processors to:
receive a redirection message from the selected host device, wherein the redirection message includes information that identifies a target host device and indicates that a current load at the selected host device exceeds an overload threshold; and
connect to the target host device identified in the redirection message.
